(19) United States
(12) Patent Application Publication
(10) Pub. No.: US 2016/0376767 A1
(43) Pub. Date: Dec. 29, 2016

(54) METHODS, SYSTEMS, AND APPARATUSES FOR VARIABLE-DEPTH MICROTRENCHING

(71) Applicant: CertusView Technologies, LLC, Palm Beach Gardens, FL (US)

(72) Inventor: Daniel Paul Miller, Brush Prairie, WA (US)

(21) Appl. No.: 15/192,690

(22) Filed: Jun. 24, 2016

Related U.S. Application Data
(60) Provisional application No. 62/184,210, filed on Jun. 24, 2015.

(51) Int. Cl. E02F 5/08; B28D 7/02; B28D 1/04

(52) U.S. Cl. CPC E02F 5/08; B28D 1/045; B28D 7/02

(57) ABSTRACT

Methods, systems and apparatus for variable-depth microtrenching (e.g., for burying fiber optic cables, electrical conductors, and conduits beneath a ground surface of a road or other byway). An automated blade adjustment mechanism coupled to a cutting blade adjusts a depth of the microtrench by raising or lowering the cutting blade during the microtrenching operation. The ability to raise or lower the cutting blade in an automated fashion during the microtrenching operation facilitates effective microtrenching through elevated or depressed obstacles (e.g., speed bumps, curbs, water drainage channels) that may be present in a byway for vehicles or pedestrians. In particular, in one example, substantially uninterrupted formation of a microtrench through an elevated or depressed obstacle may be achieved in a single swath without stopping the microtrenching operation and while maintaining a substantially uniform, or minimum prescribed, microtrench depth.

### CROSS REFERENCE TO RELATED APPLICATIONS

The present application claims a priority benefit, under 35 U.S.C. §119(e), to U.S. provisional application Ser. No. 62/184,210, filed Jun. 24, 2015, entitled “METHODS, SYSTEMS, AND APPARATUSES FOR VARIABLE-DEPTH MICROTRENCHING.”

### BACKGROUND

Conventional methods of forming a trench through and below a road covering surface (e.g., pavement comprising asphalt or concrete) include using a concrete or masonry saw to cut two parallel cuts through the covering surface spaced a distance apart. The separation distance between the parallel cuts is typically determined by the width of an excavator bucket that is used after the saw cuts are made to scoop the covering surface and subsurface from between the parallel cuts. These conventional trenching methods are relatively time consuming and expensive, and also are not suitable for forming relatively narrow and shallow trenches through and below the road covering surface. These conventional methods also obstruct the flow of traffic and leave the covering surface with an unsightly, patchwork appearance.

Various advances in utility infrastructure, and particularly buried utility cables, pipes, conduits and the like, have warranted alternative trenching approaches. For example, to address some of the problems associated with conventional trenching methodologies and accommodate advances in underground utility infrastructure, a technique referred to as “microtrenching” was developed for specialized applications such as the installation of buried fiber optic cables. Current methods for forming a “microtrench” into a ground surface include using, for example, a microtrenching apparatus having a rotating cutting blade that can cut through the ground surface (e.g., the top surface of a covering material such as pavement) and into material immediately below the ground surface (e.g., bulk material constituting the pavement, and in some instances through the bulk material constituting the pavement and into a base layer below the pavement).

In current microtrenching apparatus, the cutting blade is mounted in a blade housing, and a blade motor to rotate the cutting blade is coupled to the blade housing and in turn to the cutting blade itself. The microtrenching apparatus comprising the blade motor, cutting blade and blade housing generally is mounted on the rear of a utility or special-purpose vehicle (e.g., a tractor), and is pulled by the vehicle on the road while the cutting blade cuts through the road covering surface and into the material immediately below the covering surface. This leaves a microtrench through and below the covering surface having a width that is approximately equal to the width of the blade. Some examples of conventional microtrenching systems include MT12® Microtrencher commercially available from DITCH WITCH®, and MTR12® and MTR16® trenchers commercially available from VERMEER®.

### SUMMARY

The Inventor has recognized and appreciated certain improvements to conventional microtrenching techniques for forming relatively narrow and shallow trenches through road covering surfaces. In various inventive embodiments discussed in detail herein, certain improvements relate to effective and efficient microtrenching of roadways (or other byways for vehicles or pedestrians) in which a road covering surface includes appreciable and/or relatively sudden changes in a level of the road covering surface, as encountered for example with speed bumps, curbs, or water drainage channels.

For example, as a microtrenching apparatus is pulled by a vehicle during a microtrenching operation, often in urban or suburban environments there are elevated obstacles like speed bumps and curbs in the prospective path of the microtrench. Since elevated obstacles rise above a nominal level of the road covering surface, the depth of the microtrench (i.e., from the top of an elevated obstacle to the bottom of the microtrench) would need to be increased as the trench is formed through the elevated obstacle in order to maintain a substantially level bottom for the microtrench. Depressed obstacles like water drainage channels present a different problem. If a particular microtrenching operation requires a minimum target depth for the microtrench below a nominal level of the road surface (e.g., a four-inch deep microtrench), the presence of one or more depressed obstacles in the prospective path of the microtrench dictate that the trench should be at the minimum target depth as it traverses the depressed obstacle(s). This in turn requires cutting deeper into the road covering surface at the nominal level to either side of the depressed obstacle(s) to maintain a substantially level bottom for the microtrench, or at least cutting more deeply as the microtrenching apparatus traverses the depressed obstacle.

When employing conventional microtrenching apparatus, traversing elevated or depressed obstacles requires stopping the microtrenching operation to manually adjust the blade position in its housing so as to change cutting depth, or use of a different machine which has been preconfigured for cutting deeper or more shallow microtrenches. Both cases delay formation of the microtrench and increase the expense of the operation.

In view of the foregoing, various embodiments of the present invention are directed to methods, systems and apparatuses for variable-depth microtrenching and, more specifically, to methods, systems and apparatus for microtrenching through elevated and depressed obstacles relative to a nominal grade or level of a ground surface.

For purposes of the present disclosure, the term “ground surface” is used herein generally to refer to any surface through which a microtrench may be formed. The ground surface is intended to be understood as exposed to the ambient environment as a surface that is traversed by pedestrians and/or vehicles. In some embodiments disclosed herein, the ground surface is a top surface of a covering material (e.g., some form of pavement, such as asphalt, concrete, or other relatively harder substance to support vehicular traffic) constituting a byway (e.g., road, sidewalk) for pedestrians and/or vehicles. The ground surface is supported immediately below by a sub-surface material of some depth (e.g., a concrete ground surface on which a pedestrian and/or vehicle passes may comprise concrete material immediately below the surface for some depth or thickness). In some instances, the sub-surface material may be disposed on a layer of a different base material (e.g., an asphalt pavement road covering material may be supported immediately below by some depth of asphalt, which in turn sits on one or more sub-base layers of aggregate, crushed stone, etc.).

In the various exemplary embodiments discussed herein, the term “microtrenching” refers generally to forming a channel or void (also referred to as a “microtrench”) through a ground surface and into the sub-surface material below the ground surface using a cutting blade. The cutting blade constitutes part of a microtrenching apparatus that is generally coupled to a utility or special purpose vehicle (e.g., a tractor or other construction vehicle) that is operable to traverse the ground surface together with the microtrenching apparatus to effect cutting through the ground surface by the cutting blade. In this fashion, relatively long lengths of microtrenches may be formed having a relatively narrow width that allows for unobstructed traffic patterns on a roadway in which microtrenching is being performed (e.g., other “normal-use” vehicles such as automobiles, trucks, buses, motorcycles using the roadway for conventional travel purposes may drive over or along the microtrench without interruption or problem). Microtrenches are deep enough to protect utility infrastructure deployed in the microtrench from damage arising from the traversal of “normal-use” vehicles over the ground surface; at the same time, generally a microtrench is not so deep as to cross an existing underground utility such as an electric, gas, water, cable, or telephone line.

In the various exemplary embodiments discussed herein, the term “elevated obstacles” refers generally to objects that rise above an average or nominal grade or level of a ground surface. For example, a speed bump and a curb can significantly rise above the level of a ground surface. These objects become obstacles to the formation of the microtrench when situated in the path of the microtrenching operation.

In the various exemplary embodiments discussed herein, the term “depressed obstacles” refers generally to objects that dip below, fall below, or are sunken below an average or nominal grade or level of a ground surface. For example, a water drainage ditch can dip below the level of a road covering surface. These objects become obstacles to the formation of the microtrench when situated in the path of the microtrenching operation.

In sum, one innovative aspect of the subject matter described in this disclosure is implemented in an apparatus comprising a utility or special-purpose vehicle for driving on a ground surface, wherein the vehicle is attached to a cutter that forms a microtrench. The cutter has a blade adjustment mechanism that allows a cutting blade of the cutter to be raised or lowered in an automated fashion relative to an opening of a blade housing of the cutter. While keeping the blade housing at an essentially fixed height with respect to a nominal level of the ground surface, a depth of the microtrench can be adjusted in an automated fashion. Similarly, while keeping the depth of the microtrench essentially fixed with respect to the nominal level of the ground surface, the height of the blade housing above the ground surface can be temporarily adjusted to traverse an elevated obstacle.

Another innovative aspect of the subject matter described in this disclosure is implemented in an system comprising a utility or special-purpose vehicle for towing and powering a cutter, the cutter, and a vacuum system for collecting debris as the microtrench is formed.

Another innovative aspect of the subject matter described in this disclosure is implemented in a method comprising forming a microtrench though a ground surface that includes an elevated obstacle. As the cutter approaches the elevated obstacle, the blade housing is raised while the cutting blade position is maintained (or the microtrench depth is substantially maintained). Thus, a microtrench having a substantially level bottom is formed as the cutter traverses the elevated obstacle. After cutting through the elevated obstacle, the blade housing is lowered back into contact with the ground surface.

Another innovative aspect of the subject matter described in this disclosure is implemented in a method comprising forming a microtrench through an ground surface that includes a depressed obstacle. As the cutter approaches the depressed obstacle, the blade housing with respect to the top surface of the ground is maintained. A blade adjustment mechanism lowers the cutting blade from the blade housing to form a microtrench that maintains a minimum depth below the surface of the ground and the lowest point of the depressed obstacle. After cutting through the depressed obstacle, the cutting blade is raised back to its previous position with respect to the ground surface as the microtrenching operation continues.

Another innovative aspect of the subject matter described in this disclosure is implemented in an apparatus for forming a microtrench through a ground surface comprising a blade housing configured to mechanically support and substantially surround a cutting blade when the cutting blade is installed in the blade housing. The apparatus can also include an automated blade adjustment mechanism operably coupled to the blade housing to vary, in response to a control input, a position of the cutting blade within the blade housing, when the cutting blade is installed in the blade housing, so as to correspondingly vary a depth of the microtrench relative to the ground surface. The apparatus can include at least one port in the blade housing for conducting debris created by the cutting blade cutting the microtrench. The apparatus can also include the cutting blade for cutting the microtrench through the ground surface. The blade housing includes a base forming a blade opening for the cutting blade to protrude for cutting the microtrench, the base configured to substantially contact the ground surface flanking and along a length of the microtrench during use of the apparatus.

Another innovative aspect of the subject matter described in this disclosure is implemented in an apparatus for forming a microtrench through a ground surface and into a sub-surface material. The microtrench may be formed through the ground surface and through a sub-surface material and into a base material.

Another innovative aspect of the subject matter described in this disclosure is implemented in an apparatus that includes a single, circular blade having a cutting perimeter, a diameter, and a central hub portion for attachment to the apparatus. The diameter of the cutting blade can be from about 24 inches to about 48 inches. The cutting perimeter of the cutting blade can have a first thickness and the central hub portion of the cutting blade can have a second thickness, wherein the first thickness is greater than the second thickness. The cutting perimeter of the cutting blade can be configured to form the microtrench having a width from 0.5 inches to about 1.5 inches in a single pass. The cutting perimeter of the cutting blade can also be diamond impregnated or include removable conical cutting teeth and/or fixed teeth. The cutting perimeter of the cutting blade can also be configured to cut in only one rotational direction.

Another innovative aspect of the subject matter described in this disclosure is implemented in an apparatus that includes a blade housing further comprising a first side and a second side, and the first side of the blade housing mechanically supports the cutting blade. The second side of the blade housing can be removably coupled to the first side of the blade housing. The first side, the second side, and the base can form an inner volume, the inner volume significantly reduced to facilitate improved vacuum performance. The apparatus can be configured to be raised, lowered, tilted side-to-side, and angled front-to-back with respect to the ground surface. The blade housing can include at least one vent to facilitate air flow when used with a vacuum system. The at least one vent is adjustable for attaining a particular rate for the air flow within the blade housing.

Another innovative aspect of the subject matter described in this disclosure is implemented in an apparatus that includes at least one port in the blade housing is located proximate to a point where the cutting blade exits the ground surface during formation of the microtrench and extends in a direction tangential to a circumference of the cutting blade, the at least one port for connecting to a vacuum system. The apparatus can also include a blade housing further comprises a first side and a second side and the at least one port in the blade housing is located on the first and/or the second side of the blade housing and proximate to a point where the cutting blade cuts through the ground surface during formation of the microtrench, the at least one port for attaching a debris chute.

Another innovative aspect of the subject matter described in this disclosure is implemented in an apparatus that includes a blade motor for powering the cutting blade. The blade motor can be hydraulically, pneumatically, electrically, or mechanically powered by an internal combustion engine or electric generator. More specifically, the blade motor can be hydraulically powered by an internal combustion engine. The blade motor can change position as the cutting blade changes position. The blade motor can comprise a direct drive to the cutting blade or a transmission disposed between the blade motor and the cutting blade.

Another innovative aspect of the subject matter described in this disclosure is implemented in an apparatus that includes a blade adjustment mechanism that can provide for a change in the position of the cutting perimeter of the cutting blade relative to the base of the blade housing while the cutting blade is rotating so as to vary the depth of the microtrench through the ground surface. The change can occur without stopping formation of the microtrench. A power source can power the blade adjustment mechanism in two opposite directions. The power source can be hydraulic, pneumatic, or electric. The blade adjustment mechanism can provide continuous adjustability between two endpoints of adjustment.

Another innovative aspect of the subject matter described in this disclosure is implemented in an apparatus that includes a sealing member to seal a slot exposed in the first side of the blade housing when the blade adjustment mechanism raises the position of the cutting blade within the blade housing. The sealing member can be a folded membrane. The sealing member can be a polymer and/or a rubber material. The sealing member can also be a metal sheet or a polymer sheet.

Another innovative aspect of the subject matter described in this disclosure is implemented in a system for forming a microtrench through a ground surface having an elevated obstacle or a depressed obstacle in a path of formation, the system comprising a cutter for forming the microtrench through the ground surface. The cutter comprises a cutting blade for cutting the microtrench through the ground surface, a blade motor for powering the cutting blade, a blade housing configured to mechanically support and substantially surround a cutting blade when the cutting blade is installed in the blade housing. The cutter comprises at least one port in the blade housing for conducting debris created by the cutting blade cutting the microtrench; and an automated blade adjustment mechanism operably coupled to the blade housing to vary, in response to a control input, a position of the cutting blade within the blade housing, when the cutting blade is installed in the blade housing, so as to correspondingly vary a depth of the microtrench relative to the ground surface. The system also includes a first vehicle coupled to the cutter for advancing the cutter during formation of the microtrench through the ground surface. The first vehicle comprises a power source for powering the blade adjustment mechanism and for powering the cutting blade, and an operator control station, the operator control station including an output device for transmitting the control input to the blade adjustment mechanism.

Another innovative aspect of the subject matter described in this disclosure is implemented in a system for forming a microtrench through a ground surface having an elevated obstacle or a depressed obstacle in a path of formation, also includes a vacuum system for collecting the debris created by the cutting blade cutting the microtrench that includes a flexible hose coupled to the at least one port of the blade housing. The system can also comprise a second vehicle coupled to the vacuum system. The system can include a blade housing comprising a base forming a blade opening for the cutting blade to protrude for cutting the microtrench, the base configured to substantially contact the ground surface flanking and along a length of the microtrench during use of the apparatus.

Another innovative aspect of the subject matter described in this disclosure is implemented in a method of forming a microtrench through a ground surface and into a sub-surface material below the ground surface using a cutting apparatus. The method comprises varying a position of a cutting blade within a blade housing of the cutting apparatus, via a hydraulic blade adjustment mechanism, so as to vary a depth of the microtrench relative to the ground surface while forming the microtrench.

Another innovative aspect of the subject matter described in this disclosure is implemented in a method comprising forming a first portion of the microtrench through the ground surface, the first portion of the microtrench having a first depth; and forming a second portion of the microtrench through the ground surface, the second portion of the microtrench having a second depth. The second portion of the microtrench is formed by varying the position of a cutting blade within a blade housing of the cutting apparatus, via a hydraulic blade adjustment mechanism.

Another innovative aspect of the subject matter described in this disclosure is implemented in a method comprising varying the position of a cutting blade within a blade housing of the cutting apparatus, via a hydraulic blade adjustment mechanism, occurs concurrently with advancing the cutting apparatus. A blade housing can include a base forming a blade opening for the cutting blade to protrude for cutting the microtrench, and the method can comprise contacting the base of the blade housing with the ground surface flanking along first portion and the second portion of the microtrench during formation of the microtrench.

Another innovative aspect of the subject matter described in this disclosure is implemented in a method of forming a microtrench through a ground surface and into a sub-surface material selected from a group consisting of pavement, paving, concrete, asphalt, blacktop, cobblestone, brick, road base, and combinations thereof. A method can also include forming a microtrench into a base material selected from a group consisting of base, sub-base, stone, course asphalt, dirt, sand, concrete, binder course, clay, aggregate, rubble, and combinations thereof. A microtrench can have a depth from about 2 inches to about 15 inches and a width from about 0.5 inches to about 1.5 inches.

Another innovative aspect of the subject matter described in this disclosure is implemented in a method of forming a microtrench through a ground surface having a substantially flat bottom using a cutting apparatus. The ground surface can include an elevated obstacle. The method comprises forming a first portion of the microtrench through the ground surface with the cutting apparatus. The cutting apparatus comprises a blade housing configured to mechanically support and substantially surround a cutting blade when the cutting blade is installed in the blade housing, and an blade adjustment mechanism operably coupled to the blade housing to vary, in response to a control input, a position of the cutting blade within the blade housing, when the cutting blade is installed in the blade housing, so as to correspondingly vary a depth of the microtrench relative to the ground surface. The method also includes varying the position of the cutting blade within the blade housing of the cutting apparatus, via the blade adjustment mechanism, so as to vary the depth of the microtrench relative to the ground surface. The method also includes forming a second portion the microtrench though the elevated obstacle with the cutting apparatus, the microtrench having the substantially flat bottom.

Another innovative aspect of the subject matter described in this disclosure is implemented in a method of forming a microtrench cut into a sub-surface material selected from a group consisting of pavement, paving, concrete, asphalt, blacktop, cobblestone, brick, road base, and combinations thereof. The microtrench can also be cut into a base material selected from a group consisting of base, sub-base, stone, course asphalt, dirt, sand, concrete, binder course, clay, aggregate, rubble, and combinations thereof. The method can include forming a microtrench with a depth from about 2 inches to about 15 inches and a width from about 0.5 inches to about 1.5 inches.

Another innovative aspect of the subject matter described in this disclosure is implemented in a method of forming a microtrench includes forming the first portion of the microtrench through the ground surface and forming the second portion the microtrench though the elevated obstacle are performed sequentially without stopping formation of the microtrench. A method also includes varying the position of the cutting blade within the blade housing and forming a second portion the microtrench though the elevated obstacle are performed concurrently such that the position of the cutting blade is varied as the second portion of the microtrench is cut through the elevated obstacle. Varying the position of the cutting blade within the blade housing can include lowering the blade adjustment mechanism to extend the cutting blade from the blade housing of the cutting apparatus.

Another innovative aspect of the subject matter described in this disclosure is implemented in a method of forming a microtrench through a ground surface using a cutting apparatus, the ground surface including a depressed obstacle and the microtrench having a minimum depth below the depressed obstacle. The method comprises forming a first portion of the microtrench through the ground surface with the cutting apparatus. The cutting apparatus comprises a blade housing configured to mechanically support and substantially surround a cutting blade when the cutting blade is installed in the blade housing, and a blade adjustment mechanism operably coupled to the blade housing to vary, in response to a control input, a position of the cutting blade within the blade housing, when the cutting blade is installed in the blade housing, so as to correspondingly vary a depth of the microtrench relative to the ground surface. The method can also include varying the position of the cutting blade within the blade housing of the cutting apparatus, via the blade adjustment mechanism, so as to vary the depth of the microtrench relative to the ground surface and forming a second portion the microtrench though the depressed obstacle, the microtrench having the minimum depth below the depressed obstacle.

Another innovative aspect of the subject matter described in this disclosure is implemented in a method of forming a microtrench through a ground surface and into a sub-surface material selected from a group consisting of pavement, paving, concrete, asphalt, blacktop, cobblestone, brick, road base, and combinations thereof. The microtrench can also cut into a base material selected from a group consisting of base, sub-base, stone, course asphalt, dirt, sand, concrete, binder course, clay, aggregate, rubble, and combinations thereof. The microtrench a depth from about 2 inches to about 15 inches and a width from about 0.5 inches to about 1.5 inches.

Another innovative aspect of the subject matter described in this disclosure is implemented in a method including forming the first portion of the microtrench through the ground surface and forming the second portion the microtrench though the depressed obstacle are performed sequentially without stopping formation of the microtrench. A method can include varying the position of the cutting blade within the blade housing and forming a second portion the microtrench though the depressed obstacle are performed concurrently such that the position of the cutting blade is varied as the second portion of the microtrench is cut through the depressed obstacle. A method can include varying the position of the cutting blade within the blade housing includes lowering the blade adjustment mechanism to extend the cutting blade from the blade housing of the cutting apparatus.

The systems, methods and devices of the disclosure each have several innovative aspects, no single one of which is solely responsible for the desirable attributes disclosed herein.

The present application is related to U.S. application Ser. No. 14/204,462, filed Mar. 11, 2014, entitled “OFFSET TRENCHING METHODS AND APPARATUS, AND VOID RESTORATION METHODS, APPARATUS AND MATERIALS IN CONNECTION WITH SAME.” The present application is also related to U.S. application Ser. No. 12/889,196, filed Sep. 23, 2010, entitled “LAYING AND PROTECTING CABLE INTO EXISTING COVERING SURFACES.” Each of the foregoing applications is hereby incorporated by reference herein in its entirety.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows an example of a cutter raised in a transport position, according to one embodiment of the present invention.

FIG. 2 shows an example of a cutter including a blade adjustment mechanism, according to one embodiment of the present invention.

FIG. 3 shows an example of a lower attachment point for a blade adjustment mechanism, according to one embodiment of the present invention.

FIG. 4 shows an example of a blade adjustment mechanism including lower and upper attachment points, according to one embodiment of the present invention.

FIG. 5 shows an example of a cutter forming a microtrench, according to one embodiment of the present invention.

FIG. 6 shows an example of a cutter forming a microtrench that is coupled to a vehicle, according to one embodiment of the present invention.

FIG. 7 shows an example of a coupling mechanism connecting a cutter to a vehicle, according to one embodiment of the present invention.

FIG. 8 shows another view of an example of a coupling mechanism connecting a cutter to a vehicle, according to one embodiment of the present invention.

FIG. 9 shows an example of a first vehicle towing a cutter that is forming a microtrench, according to one embodiment of the present invention.

FIG. 10 shows an example of a cutter forming a microtrench with the cutting blade at a raised position within the blade housing, according to one embodiment of the present invention.

FIG. 11 shows another view of an example of a vehicle towing a cutter that is forming a microtrench, according to one embodiment of the present invention.

FIG. 12 shows an example of a microtrenching system including a first vehicle towing a cutter and a vacuum source mounted to second vehicle, according to one embodiment of the present invention.

FIG. 13 shows another view of a microtrenching system including a first vehicle towing a cutter and a vacuum source mounted to second vehicle, according to one embodiment of the present invention.

FIG. 14 shows an example of a cutter forming a microtrench through an elevated obstacle, according to one embodiment of the present invention.

FIG. 15 shows another view of an example of a cutter forming a microtrench through an elevated obstacle, according to one embodiment of the present invention.

FIG. 16 shows another view of an example of a cutter forming a microtrench and approaching an elevated obstacle, according to one embodiment of the present invention.

FIG. 17 shows an example of a cutter forming a microtrench by cutting through an elevated obstacle, according to one embodiment of the present invention.

FIG. 18 shows another view of an example of a cutter forming a microtrench by cutting through an elevated obstacle, according to one embodiment of the present invention.

FIG. 19 shows an example of a cutter forming a microtrench and transitioning past the elevated obstacle, according to one embodiment of the present invention.

FIG. 20 shows an example of a cutter forming a microtrench through a ground surface after having past the elevated obstacle, according to one embodiment of the present invention.

FIG. 21 shows a cross-sectional example of a cutter forming a microtrench and approaching an elevated obstacle, according to one embodiment of the present invention.

FIG. 22 shows a cross-sectional example of a cutter forming a microtrench through an elevated obstacle, according to one embodiment of the present invention.

FIG. 23 shows a cross-sectional example of a cutter forming a microtrench after cutting through an elevated obstacle, according to one embodiment of the present invention.

FIG. 24 shows a cross-sectional example of a cutter forming a microtrench and approaching an elevated obstacle, according to one embodiment of the present invention.

FIG. 25 shows a cross-sectional example of a cutter forming a microtrench and transitioning over an elevated obstacle, according to one embodiment of the present invention.

FIG. 26 shows a cross-sectional example of a cutter forming a microtrench after cutting through an elevated obstacle, according to one embodiment of the present invention.

FIG. 27 shows a cross-sectional example of a cutter forming a microtrench and approaching a depressed obstacle, according to one embodiment of the present invention.

FIG. 28 shows a cross-sectional example of a cutter forming a microtrench and transitioning over a depressed obstacle, according to one embodiment of the present invention.

FIG. 29 shows a cross-sectional example of a cutter forming a microtrench after cutting through a depressed obstacle, according to one embodiment of the present invention.

The features and advantages of the present invention will become more apparent from the detailed description set forth below when taken in conjunction with the drawings.

### DETAILED DESCRIPTION

Following below are more detailed descriptions of various concepts related to, and embodiments of, inventive systems, methods, and apparatus for variable-depth microtrenching. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Machines for Constructing Microtrenches for Underground Cable Installation

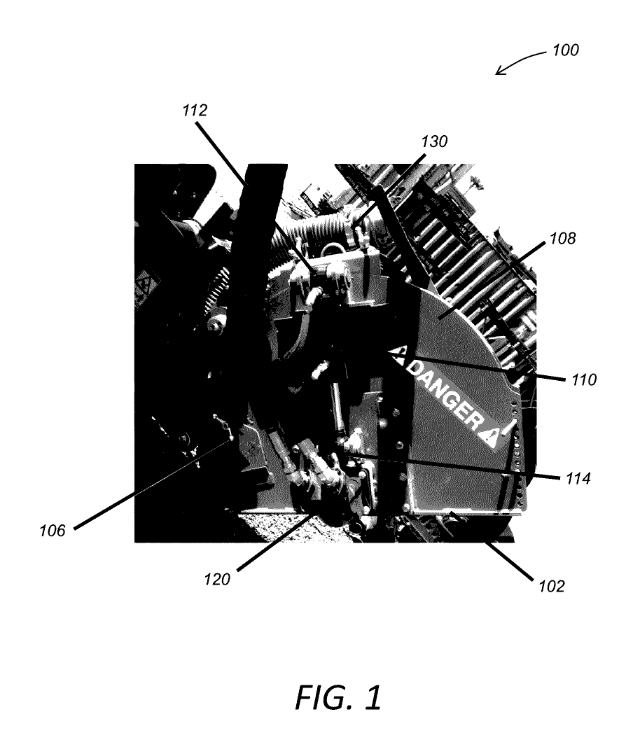

FIG. 1 shows an example of a microtrenching apparatus 100, also referred to herein as a “cutter,” for forming a microtrench, according to one embodiment of the present invention, in which the cutter is attached to a utility vehicle (not shown in FIG. 1, but shown in later figures) and raised in a transport position. In the example shown in FIG. 1, a cutting blade has not yet been attached to the cutter 100. The cutter 100 includes a blade housing 108 that surrounds a portion of a cutting blade once the blade is installed in the cutter. The blade housing 108 also includes a base 102 that forms a blade opening for the cutting blade to protrude once installed. For forming the microtrench, the base 102 is configured to substantially contact the ground surface flanking and along a length of the microtrench during use of the cutter 100.

The blade housing 108 is a structural member of the cutter 100. This means that the blade housing not only surrounds a portion of the cutting blade providing protection against accidental contact with the rotating cutting blade, but also acts as a support frame for the cutting blade. The blade housing 108 is constructed so as to support the weight and torque generated by the rotating cutting blade. To provide flexibility in a variety of microtrenching circumstances, the cutter is configured to be raised, lowered, tilted side-to-side, and angled front-to-back (e.g., relative to the ground surface).

The blade housing 108 includes a first substantially planar side and a second substantially planar side disposed opposing one another and substantially parallel to a cutting blade once installed. The first and second sides of the blade housing essentially create a partially enclosed space or inner volume in which the cutting blade resides once installed. The first side of the blade housing 108 is operably coupled to and supports the weight of the cutting blade. The second side of the blade housing 108 is removably coupled to the first side of the blade housing 108.

In one embodiment, the blade housing 108 is designed for use with (i.e., to be coupled to) a vacuum system. During microtrenching operations with a vacuum system, it is generally preferably to have a relatively lower volume for the enclosed space formed by the sides of the blade housing so as to facilitate improved vacuum performance. In this manner, the blade housing 108 generally has a profile (e.g., a perimeter shape) that resembles the shape of the portion of the cutting blade contained therein. This design significantly reduces the inner volume of the blade housing 108 to facilitate improved vacuum performance.

In one embodiment, the cutter 100 includes at least one port in the blade housing 108 for conducting debris created by the cutting blade as it cuts through a ground surface to create a microtrench. To this end, in one embodiment a vacuum hose 130 is connected to a port on the blade housing 108 located at or proximate to a point where the cutting blade exits the ground surface during formation of the microtrench. The port extends in a direction tangential to a circumference of the cutting blade. Vacuum hose 130 includes a coupling for connecting to another section of vacuum hose that is connected to a vacuum system. Vacuum hose 130 can be a relatively large diameter (ie. about 2 inches to about 6 inches) semi-rigid hose suitable for sustaining an internal vacuum and conducting a stream of debris created by the cutting blade to a vacuum collection chamber. One end of the vacuum hose is connected to a vacuuming source that includes a vacuuming pump. The other end of the vacuum hose is positioned near the circumference of the cutting blade in the path of the stream of debris resulting from the cutting operation. Vacuuming concurrently or simultaneously with the cutting operation advantageously removes the debris from the microtrench cut by the blade and at the same time prevents the debris to settle back into the microtrench. Thus, the cutting operation of the blade results in an evacuated microtrench that is ready for the next step of cable installation. Vacuuming concurrently with the rotation of the blade also results in air flow around the blade, which air flow aids in cooling the blade.

In another embodiment, the blade housing 108 is designed for use without a vacuum system. During microtrenching operations without a vacuum system, a debris chute is attached to a port 106 that is located on the first side of the blade housing 108. The second side of the blade housing 108 also has a port at the same location proximate to a point where the cutting blade exits the ground surface during formation of the microtrench. Depending on the environment, one or more debris chutes can be used to direct the debris created by the cutting blade to either side of the microtrench. When a vacuum system is used, the ports in the first and second sides of the blade housing 108 are blocked off (as shown in FIG. 1).

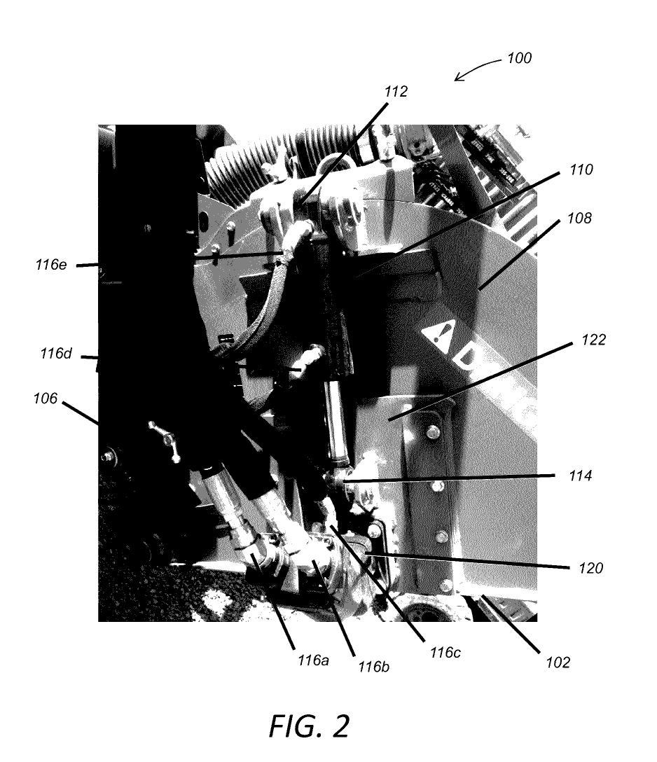

FIG. 2 is a close-up view similar to FIG. 1 and shows an example of a cutter 100 including a blade adjustment mechanism 110. The blade adjustment mechanism 110 provides for a change in a position of a cutting perimeter of a cutting blade relative to the base 102 of the blade housing 108 while the cutting blade is rotating, so as to vary the depth of the microtrench within the ground surface. In some implementations discussed in greater detail below, the blade adjustment mechanism 110 is automated and responsive to user/operator control so as to allow for a change in the position of the cutting perimeter of the cutting blade relative to the base 102 of the blade housing without significant interruption to the microtrenching operation (e.g., without stopping formation of the microtrench via the microtrenching apparatus so as to manually readjust blade position within the blade housing).

Various types of blade adjustment mechanisms may be implemented in different embodiments. For example, in some embodiments, a ball and screw actuator or various types of linear actuators can be used to implement the blade adjustment mechanism 110. In the embodiment shown in FIGS. 1 and 2, the blade adjustment mechanism 110 is implemented as a double acting hydraulic cylinder coupled to a hydraulic power source through hydraulic lines 116d and 116e. Hydraulic lines 116d and 116e may be protected in an abrasion resistant sheath that resists wear.

More generally, blade adjustment mechanism 110 can be powered by hydraulic pressure, air pressure, an electric motor, spring(s), manual mechanical means, and combinations thereof, and may be configured so as to allow the cutting blade to be positioned with respect to the blade housing so as to increase or decrease a depth of a microtrench cut by the blade (e.g., when the base 102 of the blade housing is substantially parallel to and in contact with the ground surface during a microtrenching operation, the blade may be “raised” or “lowered” within the blade housing 108 in a direction substantially normal to the ground surface). To this end, the blade adjustment mechanism 110 may be powered for position adjustments in two opposite directions (e.g., to raise the cutting blade and to lower the cutting blade).

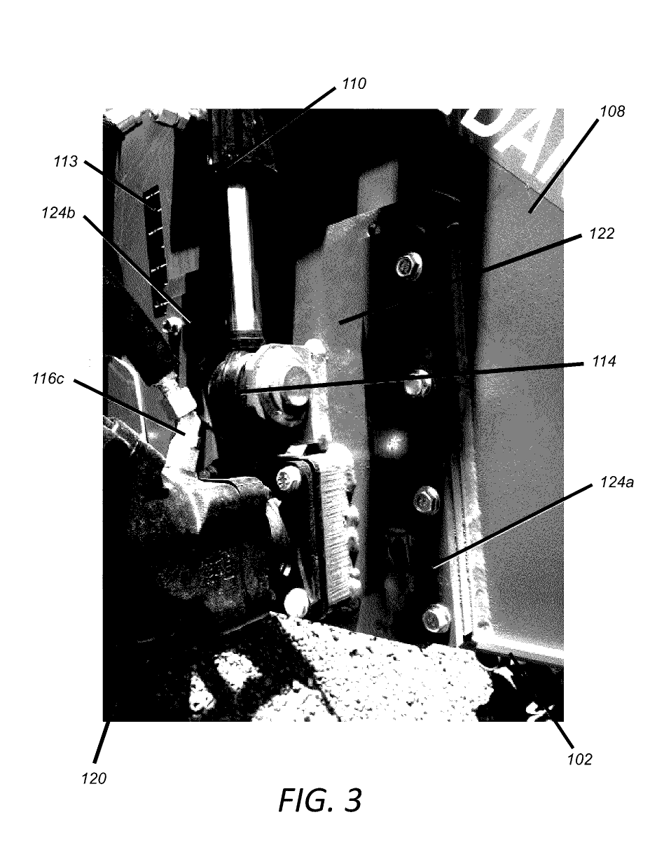

As shown in FIG. 2, the blade adjustment mechanism 110 is attached to the blade housing 108 at an upper attachment point 112 and a lower attachment point 114. The upper attachment point 112 can include a fixed pin as shown in FIG. 2, or can be a rigid connection. FIG. 3 shows an example of the lower attachment point 114 coupled to a sliding cover 122. A gauge 113 indicates the relative position of the sliding cover 122 with respect to the blade housing 108. The sliding cover 122 is held in place against the blade housing 108 with retaining members 124a and 124b, which allow the sliding cover 122 to move in a linear direction (e.g., up and down relative to the ground surface) when the blade adjustment mechanism 110 is actuated, but prevent movement of the sliding cover 122 in other directions. In addition to the lower attachment point 114 being attached to the sliding cover 122, the blade motor 120 is also securely affixed to the sliding cover 122.

The cutting blade is powered by the blade motor 120. In some embodiments, blade motor 120 is a hydraulic motor, while in other embodiments the blade motor may be pneumatically, electrically, or mechanically powered by an internal combustion engine or electric generator. In some embodiments, the blade motor 120 is coupled to the cutting blade via a motor shaft. In some embodiments, the cutting blade is cantilevered off the sliding cover 122 via the motor shaft. In these embodiments, the cutting blade can be quickly removed from the motor shaft by loosening a retaining member, such as a nut or locking collar. In other embodiments, a transmission is disposed between the blade motor 120 and the cutting blade.

The blade motor 120 imparts a rotational torque and motion to the cutting blade. In some implementations, in which the blade is a diamond blade, the blade motor can provide a rotation up to about 2000 rpm to the blade. In some other implementations, in which the blade includes carbide bits, the blade motor can provide a typical rotation speed of about 350 to 400 rpm, and up to 1000 rpm. In some implementations, the blade motor rotates the cutting blade in an anticlockwise direction when viewed from the side. Alternatively, the blade motor can rotate the blade in the clockwise direction. In some implementations, the blade motor rotates the cutting blade such that the cutting blade cuts upward through the ground surface, and the bottommost portion of the cutting blade is rotating in the same direction as the advancing microtrench.

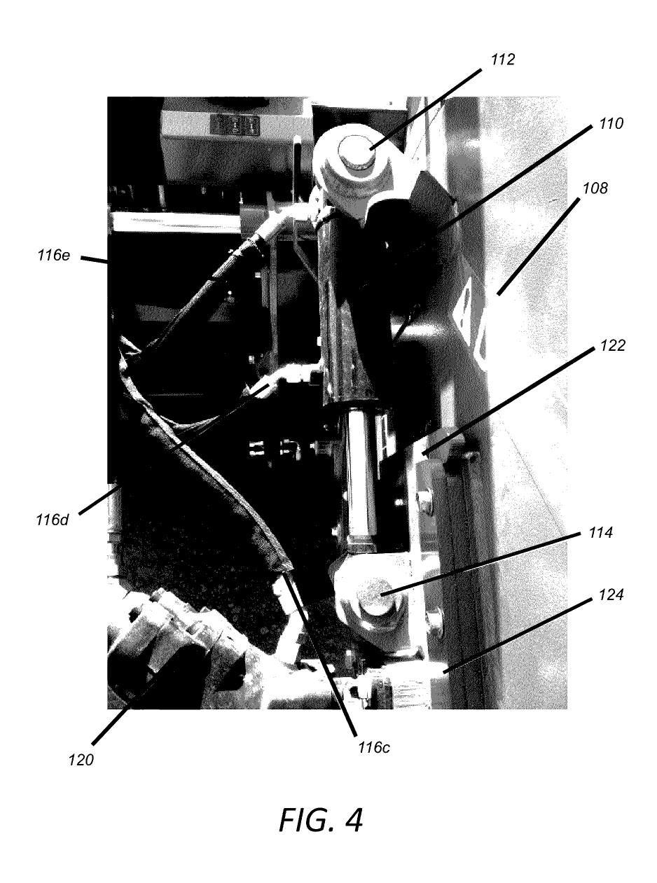

FIG. 4 shows another view of an example of a hydraulic blade adjustment mechanism 110. In one implementation, as hydraulic fluid flows to hydraulic line 116d and from hydraulic line 116e, the blade adjustment mechanism 110 raises the sliding cover 122, the blade motor 120, and cutting blade into the blade housing 108. As hydraulic fluid flows to hydraulic line 116e and from hydraulic line 116d, the blade adjustment mechanism 110 lowers the sliding cover 122, the blade motor 120, and cutting blade from the blade housing 108. In this manner, the blade adjustment mechanism 110 can precisely control the portion of the cutting blade extending from the base 102 of the blade housing 108. The blade adjustment mechanism 110 provides continuous adjustability between two endpoints of adjustment (e.g., one endpoint position corresponding to the cutting blade being fully retracted into the blade housing, and the other endpoint position corresponding to an edge of the cutting blade being maximally extended beyond (protruding from) the base of the blade housing.

In some embodiments, the cutting blade is a single, circular blade having a circumference, the circumference comprising a cutting perimeter, a diameter, and a central hub portion for attachment to the cutter. In some embodiments, the circumference of the cutting blade has a first thickness and the central hub portion of the cutting blade has a second thickness, wherein the first thickness is greater than the second thickness. The cutting blade can have a thickness and diameter sufficient to cut the desired microtrench. The thickness of the cutting blade can be one factor in determining the width of the microtrench, while the diameter of the cutting blade can be one factor in determining the depth of the microtrench. In some embodiments, the cutting perimeter of the cutting blade is diamond impregnated. Also, in some embodiments, the cutting perimeter of the cutting blade includes removable conical cutting teeth and/or fixed teeth. In some embodiments, the cutting perimeter of the cutting blade is configured to cut in only one rotational direction. In some embodiments, the cutting blade has a diameter of between about 24 inches to about 48 inches, with a preferred diameter of 34 inches. In some embodiments, the cutting perimeter of the cutting blade has a width of between about 0.5 inch to about 1.5 inches in order to cut microtrench having a width of between about 0.5 inch to about 1.5 inches in a single pass.

In some implementations, the cutting blade is maintained substantially vertical during formation of the microtrench. It should be noted that maintaining the cutting blade substantially vertical provides several benefits. For example, a substantially vertical cutting blade results in the blade cutting a substantially vertical microtrench in the ground. As a result, the width of the microtrench will be predictably close to the width of the cutting blade. Furthermore, a non-vertical cutting blade cutting any material will experience more wear and tear than a vertical cutting blade. Therefore, by maintaining the cutting blade substantially vertical, blades have to be replaced less often for a given distance. In addition, by reducing the frequency of replacement of blades, the frequency of interrupting the cutting operation is also reduced, thereby increasing the throughput of the cutter in terms of feet of microtrench constructed per unit of time.

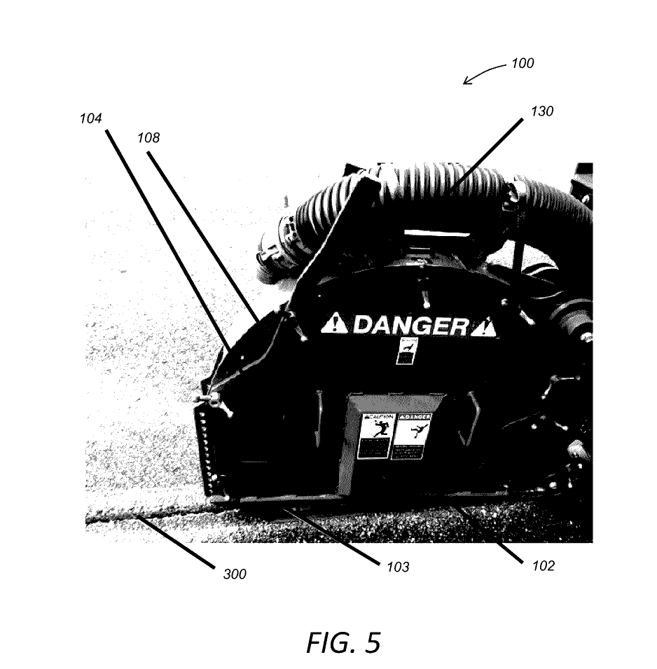

FIG. 5 shows an example of a cutter 100 forming a microtrench 300 through a ground surface and into a sub-surface material immediately below the ground surface. In some implementations, the cutter 100 is configured for forming the microtrench through the ground surface and through the sub-surface material and into the base material. In some implementations, the cutter 100 is configured for forming the microtrench through the ground surface and within the sub-surface material only, and not into the base material. To achieve a shallow depth microtrench within the sub-surface material, in some implementations cutter 100 can include a spacer 103 removably coupled to the base 102 of the blade housing 108. In some embodiments, the spacer 103 has a ground profile that is substantially similar to the ground profile of the base 102 that contacts with the ground surface when the spacer 103 is not in use. When a spacer 103 is coupled to the base 102, the spacer effectively forms a new base of the blade housing 108. The spacer 103 raises the height of the blade housing 108 and cutting blade above the ground surface. In some embodiments, spacer 103 can have a height from about 1 inch thick to about 5 inches thick to effectively space the base 102 the given height above from the ground surface.

As depicted in FIG. 5, spacer 103 can be tapered from a front end to a back end. In this example, spacer 103 is tapered from about 1.5 inches at the front end proximate to a coupling mechanism to about 3 inches at the back end. The angle created by the taper of the spacer 103 and the ground surface can be selected to match the angle created by the coupling mechanism that raises and lowers the cutter 100 in an arc from the transport position to the cutting position. In this manner, the taper of the spacer 103 provides a platform or an extension of the base 102 without any additional modifications to the coupling mechanism. As mentioned above, the cutter 100 is configured to be raised, lowered, tilted side-to-side, and angled front-to-back. The taper of the spacer 103 allows for the front-to-back angle adjustment of the cutter 100 to be set to a neutral, middle position during microtrenching operations on a flat, level ground surface.

In some embodiments, the blade housing 108 includes at least one vent 104 to facilitate air flow when used with a vacuum system. In one aspect, the at least one vent may be configured (e.g., in size, placement, number, and/or distribution) to attaining a particular air flow within the blade housing (e.g., to allow additional flow of air into the blade housing 180 to be sucked by the vacuum hose along with the debris). In another aspect, one or more vents may be adjustable in some manner (e.g., in opening size) to provide for an adjustable air flow within the blade housing to accommodate various vacuum systems and microtrenching conditions. In some embodiments, one or more vents 104 may be implemented as louvers, and may have a size on the order of approximately 3-4 inches long and ⅜^{th} of an inch wide. In some embodiments, the at least one vent 104 is located on the second side of the blade housing 108.

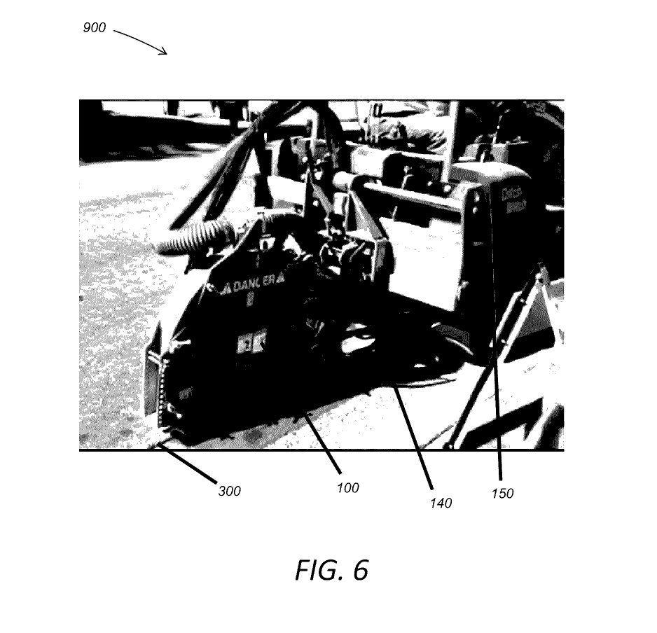

FIG. 6 shows an example of a cutter 100 that is coupled to a first vehicle or cutting machine 150, collectively a cutting machine 900, according to an embodiment of the present invention, for cutting the microtrench 300 through the ground surface. In the embodiment of FIG. 6, the utility vehicle 150 is a utility or “special purpose” vehicle (e.g., a tractor) and includes an operator control station and a chassis supported by at least three wheels or tires. The operator control station contains controls for operation of the utility vehicle 150 and the cutter 100; examples of such controls include, but are not limited to, an operator user-interface device to send a control input to the blade adjustment mechanism 110. In some implementations, the chassis of the utility vehicle 150 may be supported by tracks instead of wheels. The utility vehicle 150 includes a motor to propel the utility vehicle and the cutter attached thereto. In some embodiments, the motor of the utility vehicle 150 powers a hydraulic pump to power the hydraulics located on the cutter 100. For example, utility vehicle 150 may include a diesel motor powering a hydraulic pump which serves as the power source to the blade adjustment mechanism 110 and the cutting blade motor 120 located on the cutter 100.

In various implementations, the utility vehicle includes an attachment or mount for the cutter 100; examples of such machines include tractors commercially available from various manufacturers such as DITCH WITCH®, VERMEER®, etc. Cutter 100 is compatible with and may be used with the cutting machines and cutting systems as described in applications U.S. application Ser. No. 12/889,196, entitled “LAYING AND PROTECTING CABLE INTO EXISTING COVERING SURFACES,” and U.S. application Ser. No. 14/204,462, entitled “Offset Trenching Methods and APPARATUS, AND VOID RESTORATION METHODS, APPARATUS AND MATERIALS IN CONNECTION WITH SAME,” both of which are hereby incorporated by reference in their entirety. For example, cutter 32 of U.S. application Ser. No. 12/889,196, can be replaced with cutter 100 of the present application, and can be adapted to work with machine 30. For example, blade housings 206 and 506 of U.S. application Ser. No. 14/204,462 can be replaced with cutter 100 of the present application, and can be adapted to work with utility vehicle 200. Additionally, for example, disclosure within these prior applications related to laying cable and filling the microtrench of are also compatible with the present application.

In some implementations, due to the forces created by the rotating cutting blade during microtrenching operations and due to the design and weight of utility vehicle 150, it is preferable to pull the cutter 100, instead of pushing the cutter 100. As shown in FIG. 6, a cutter 100 is being pulled or towed by a utility vehicle 150 while forming a microtrench 300. Cutter 100 is connected to utility vehicle 150 with a coupling mechanism 140. In some implementations, cutter 100 can be mounted to a vehicle that provides stability and control for pushing the cutter 100.

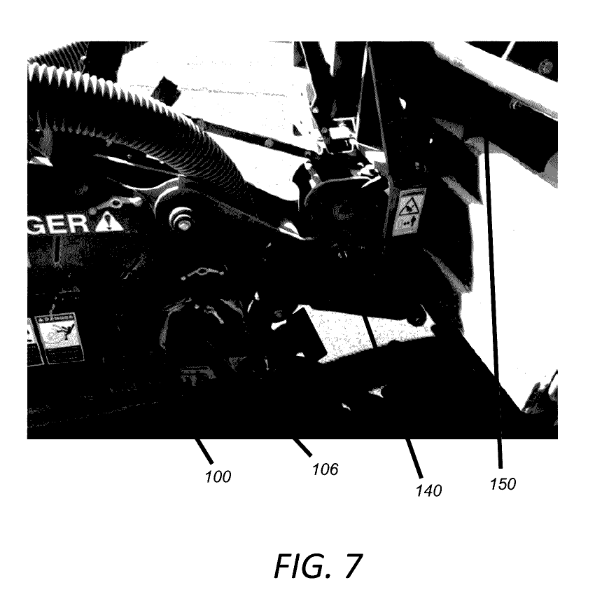

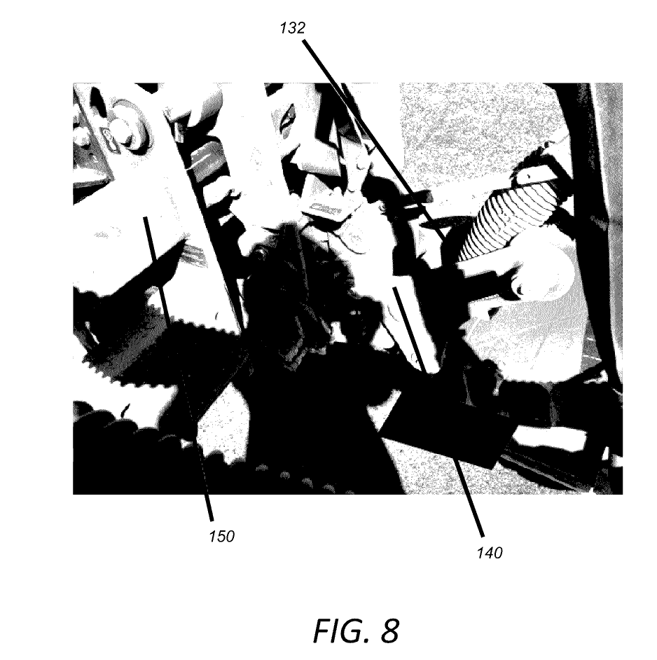

FIGS. 7 and 8 show an example of a coupling mechanism 140 connecting a cutter 100 to a utility vehicle 150. The coupling mechanism 140 allows the cutter to be raised from a cutting position and into a transport position for storage, travel, and maintenance. The coupling mechanism 140 contains linkage and hydraulic cylinders for positioning the cutter 100 in a variety of ways with respect to the utility vehicle 150 sitting on the ground surface. For example the coupling mechanism 140 allows the cutter 100 to be raised, lowered, tilted side-to-side, and angled front-to-back with respect to the ground surface. When traversing vertical obstacles, coupling mechanism 140 allows the cutter 100 to be raised and lowered.

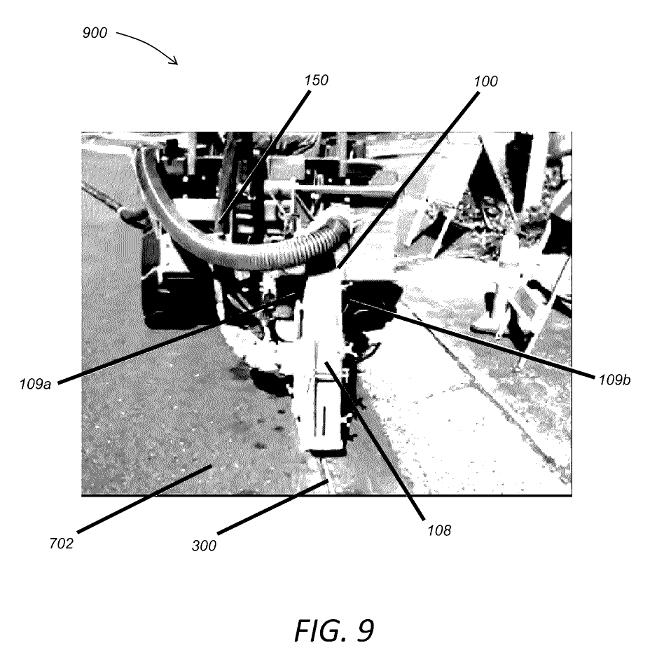

FIG. 9 shows an example of a first vehicle or utility vehicle 150 towing a cutter 100, collectively a cutting machine 900, that is forming a microtrench 300 through a ground surface 702. Cutter 100 includes a blade housing 108 having a first side 109a and a second side 109b. In one exemplary implementation, microtrenching is used for constructing a channel or void for installing underground telecommunications cables. For example, as part of performing installations of underground cables in a subdivision or planned community of homes, a microtrench 300 can be formed that acts as a primary or a main artery microtrench. The primary microtrench will later be connected to individual, secondary microtrenches which terminate at each of the homes within the subdivision or planned community.

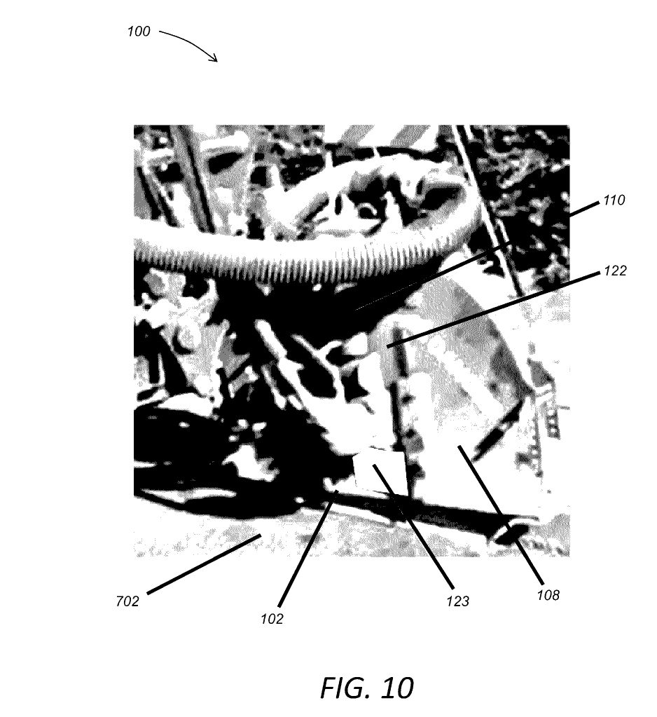

FIG. 10 shows an example of a cutter 100 forming a microtrench with the cutting perimeter of cutting blade at a raised position with respect to the base 102 of the blade housing 108. In the illustration of FIG. 10, the blade adjustment mechanism 110 is shown in a fully raised position with the cutting blade retracted within blade housing 108. A sealing member 123 extends to cover a slot exposed within the first side of the blade housing 108 as the sliding cover 122 raises. Sealing member 123 seals an opening to inhibit air from entering the blade housing 108 during microtrenching operations that use a vacuum system. The air the would otherwise pass through the exposed slot may in some instances reduce vacuum performance and lead to debris flanking the microtrench on the ground surface and also lead to debris falling back into the microtrench. Therefore, in some implementations it is desirable to significantly block off the slot with the sealing member 123 to improve vacuum performance for collecting the debris from the microtrench. To this end, a sealing member 123 may be employed to seal the slot or opening that is exposed in the first side of the blade housing 108 when the blade adjustment mechanism 110 raises sliding cover 122. In some embodiments, the sealing member 123 may be a folded membrane attached to the base 102 and the sliding door 122; in one aspect, such a membrane may be folded in an accordion fold pattern such that the folded membrane is compactly folded when the sliding cover 122 is in a lowered position. As the sliding door 122 is raised, the folded membrane expands to seal or cover the slot created in the first side of the blade housing 108. In other aspects, the sealing member may be made of, or include various materials, to facilitate one or both of sealing of the slot in the first side and flexibility as the sliding cover 122 is moved pursuant to operation of the blade adjustment mechanism; examples of such materials include, but are not limited to, a polymer and/or a rubber material, a thin metal sheet or a polymer sheet. In other aspects, the sealing member may be manually applied to the blade housing to cover the slot exposed when the sliding cover is at various positions. In these aspects, examples of the sealing member include duct tape, a wooden sheet, plastic film, and combinations thereof.

Microtrenching Systems

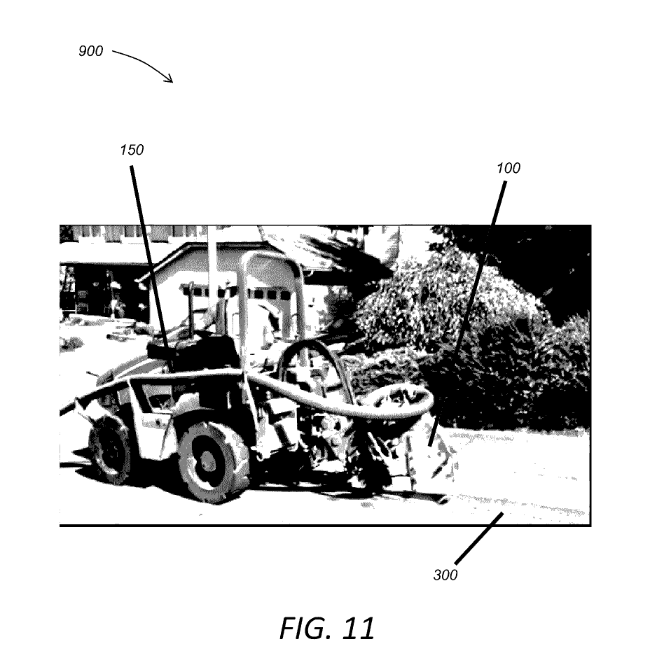

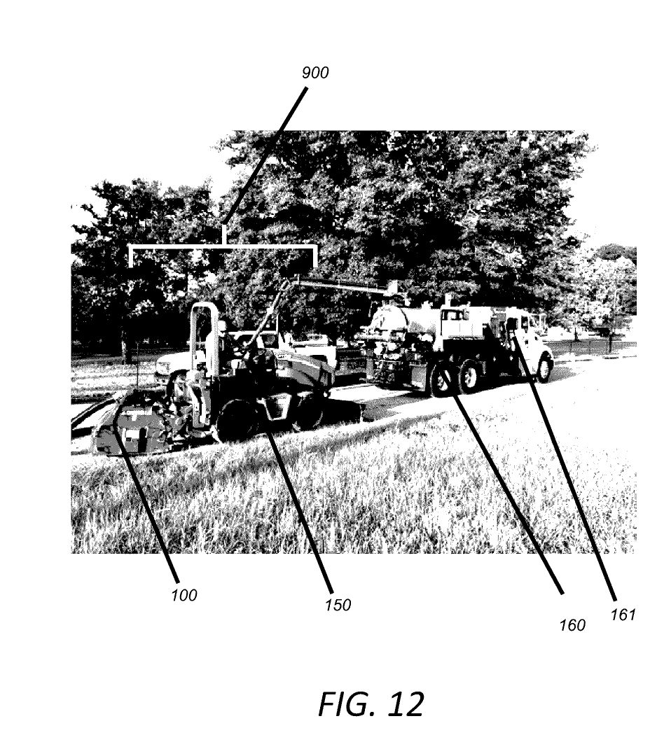

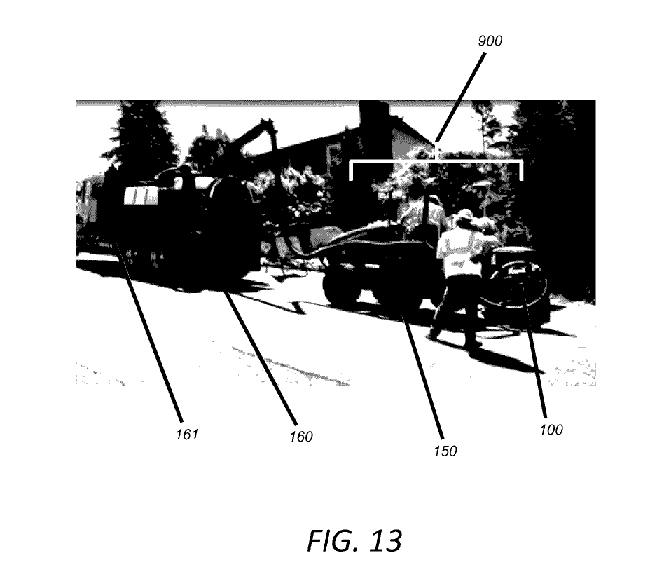

FIGS. 11-13 show examples of microtrenching systems. FIG. 12 is an example of a microtrenching system including a first vehicle or utility vehicle 150 towing a cutter 100, collectively a cutting machine 900, that is forming a microtrench 300. FIG. 12 shows an example of a microtrenching system including first vehicle or utility vehicle 150 towing a cutter 100, collectively a cutting machine 900, and a vacuum system 160 mounted to a second vehicle 161. FIG. 13 shows another view of example of a microtrenching system including first vehicle or utility vehicle 150 towing a cutter 100, collectively a cutting machine 900, and a vacuum source 160 mounted to a second vehicle 161. In other embodiments, the vacuum source 160 is mounted to the first vehicle or utility vehicle 150 or to a trailer towed by the second vehicle.

Formation of a Microtrench for Cable Installation

Discussion now turns to the methods for constructing a microtrench for cable installation. In some implementations, the microtrenching path of formation follows along a ground surface and proceeds through an elevated obstacle before returning back to the ground surface. In some implementations, the microtrenching path of formation begins on a ground surface and proceeds over an elevated obstacle and continues along the elevated surface. In some implementations, the microtrenching path of formation follows along an elevated surface and proceeds down the elevated obstacle and then continues along the ground surface.

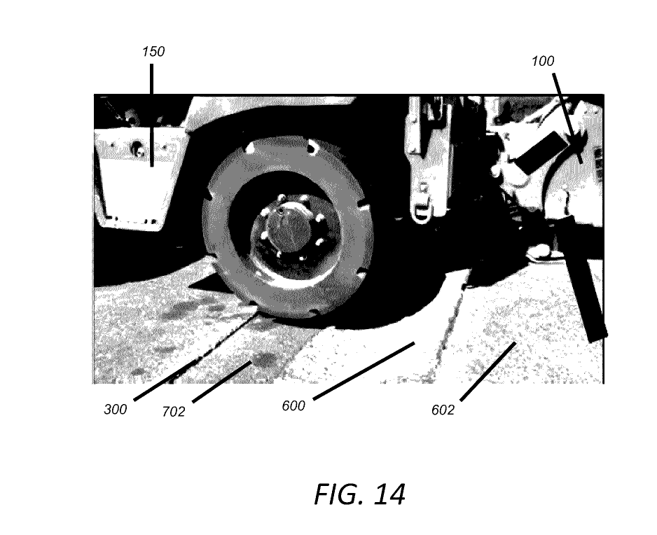

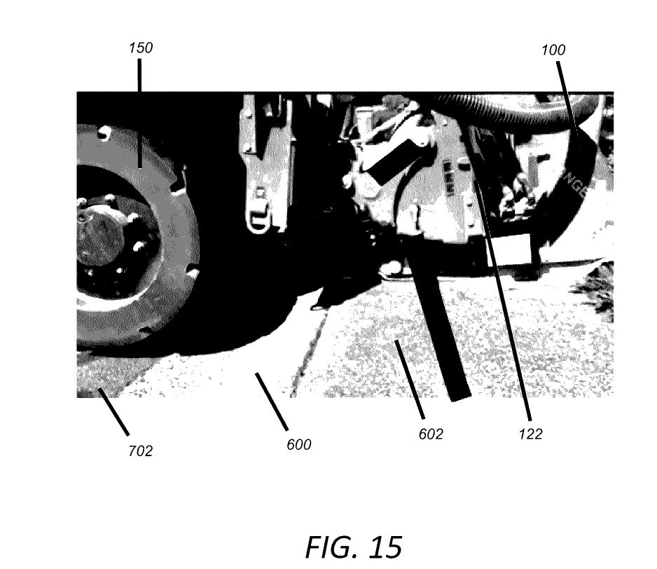

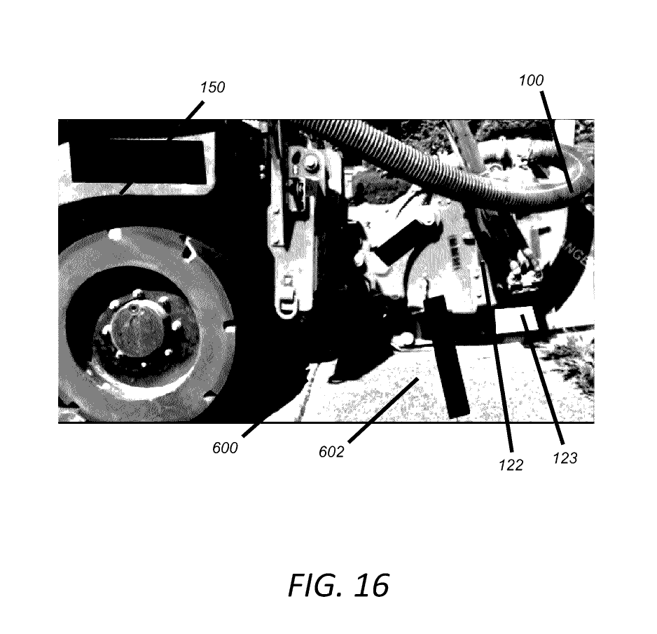

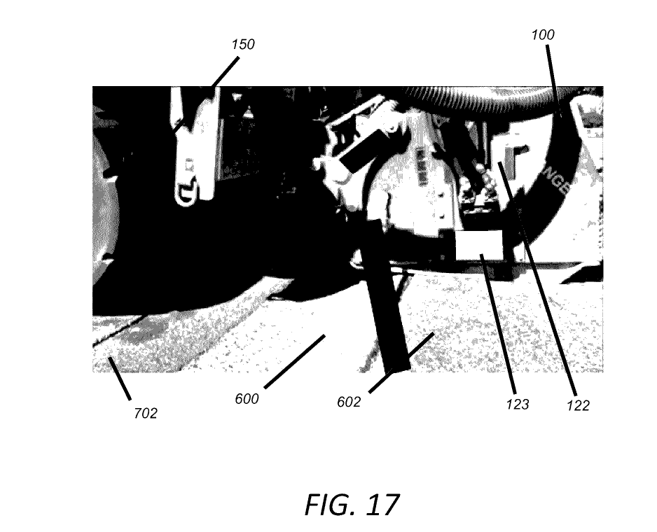

FIGS. 14-20 show an example of a cutter 100 forming a microtrench over an elevated obstacle 600. In this example, the cutter 100 is constructing a secondary microtrench from a home that will intersect with a primary microtrench. The cutter 100 is forming a microtrench through elevated obstacle top surface 602. The front wheels (not shown) of utility vehicle 150 is on the ground surface 702. Due to the pressure exerted by the utility vehicle 150 that is pressing the cutter 100 in contact with elevated obstacle top surface 602, the rear wheels of the utility vehicle 150 are slightly raised off of the ground surface 702. As shown in FIGS. 15, 16 and 17, sliding cover 122, the blade motor, and the cutting blade are in a raised position expanding a sealing member 123 to cover an opening in the first side of the blade housing created by the raising the sliding cover 122. In FIG. 17, the cutter 100 is just beginning to cross the edge of elevated obstacle 600. The operator is beginning to trigger a control input to the blade adjustment mechanism to lower the cutting perimeter of the cutting blade to maintain the minimum microtrench depth.

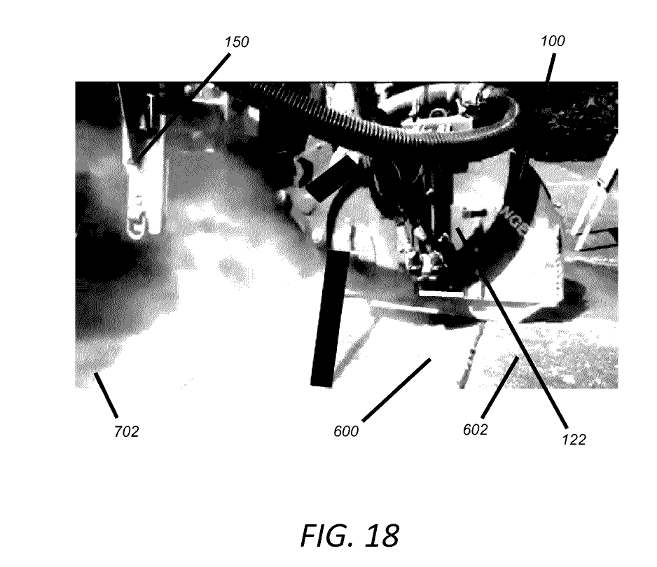

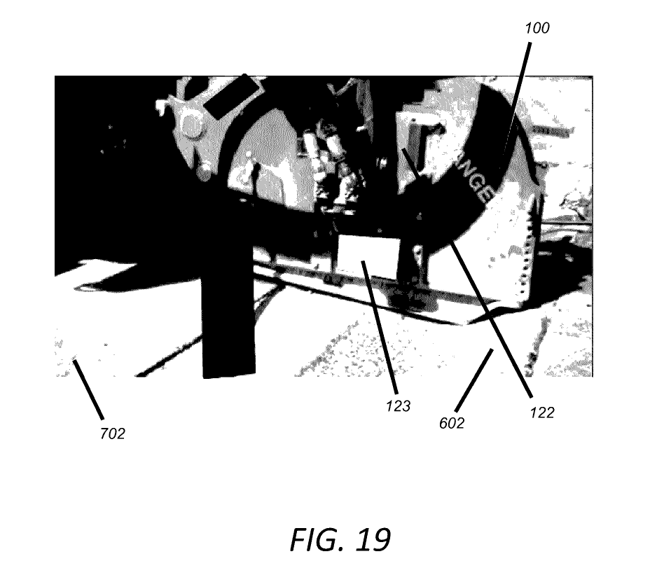

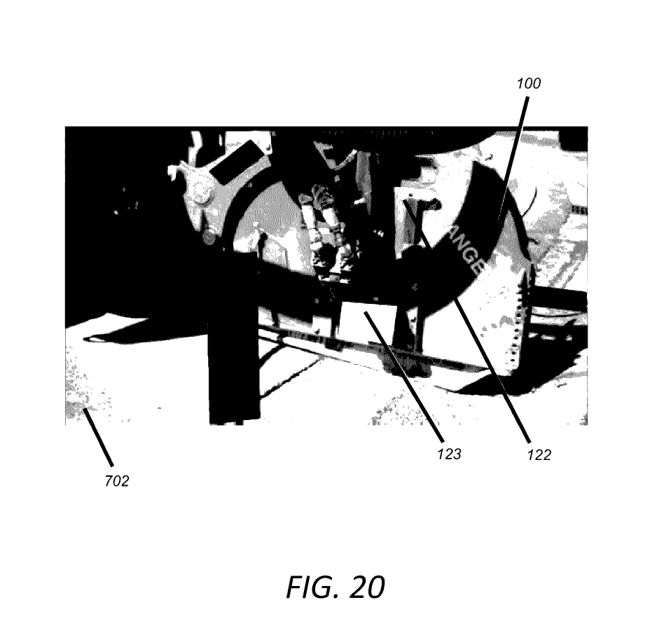

FIG. 18 shows the sliding cover 122 in lowered position as the cutter 100 traverses the elevated obstacle 600. Because the base of the blade housing is no longer in contact with the ground surface, the vacuum performance diminishes rapidly and dust and debris fill the air. In FIGS. 19 and 20, the cutter 100 returns to the ground surface 702, the sliding cover 122 and the cutting blade are raised with respect to the blade housing, and the microtrenching operation continues forming a microtrench through ground surface 702.

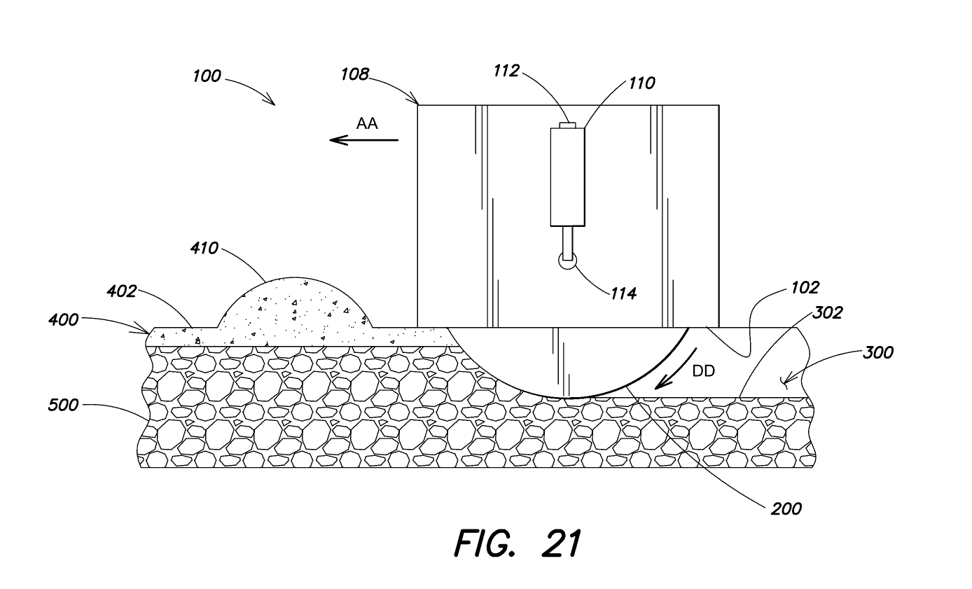

FIGS. 21, 22, and 23 show examples of cross-sectional views of constructing a microtrench for a cable installation, according to an embodiment of the present invention. In one embodiment, the microtrench 300 is formed to facilitate laying (burying) of utility infrastructure, such as fiber optic cable, electrical conductors (e.g., power cables, telecommunications wire cables), or conduit, for example (hereafter, referred to simply as “cables”). As the cutting blade 200 spins in direction DD, the cutter 100 advances in direction AA forming the microtrench 300 through the ground surface 402, through/into the sub-surface material 400, and into the base material 500. The base 102 of the blade housing 108 is in contact with the ground surface 402 and provides a seal for a vacuum applied to the blade housing 108, and also prevents the sub-surface material 400 from breaking apart as the cutting blade 200 rotates upward in direction DD through the ground surface 402 as the cutting blade 200 cuts the microtrench. In some implementations, the blade housing 102 is forced against the covering surface 402 by a coupling mechanism attached to a utility machine.

A path of formation of the microtrench along the ground surface includes an elevated obstacle 410, which could be a speed bump, speed hump, ramp, parking stop, or the like. The elevated obstacle 410 is typically situated transverse to the direction AA of the advancing microtrenching operation which necessitates cutting through the elevated obstacle 410, rather than forming a microtrench around it. The elevated obstacle 410 can have a height of, but is not limited to, about 1-6 inches, about 1-5 inches, about 1-6 inches, about 1-3 inches, about 1-2 inches, about 2-6 inches, about 2-5 inches, about 2-4 inches, about 2-3 inches, about 4-6 inches, about 4-5 inches, about 3-6 inches, about 3-5 inches, or about 3-4 inches.

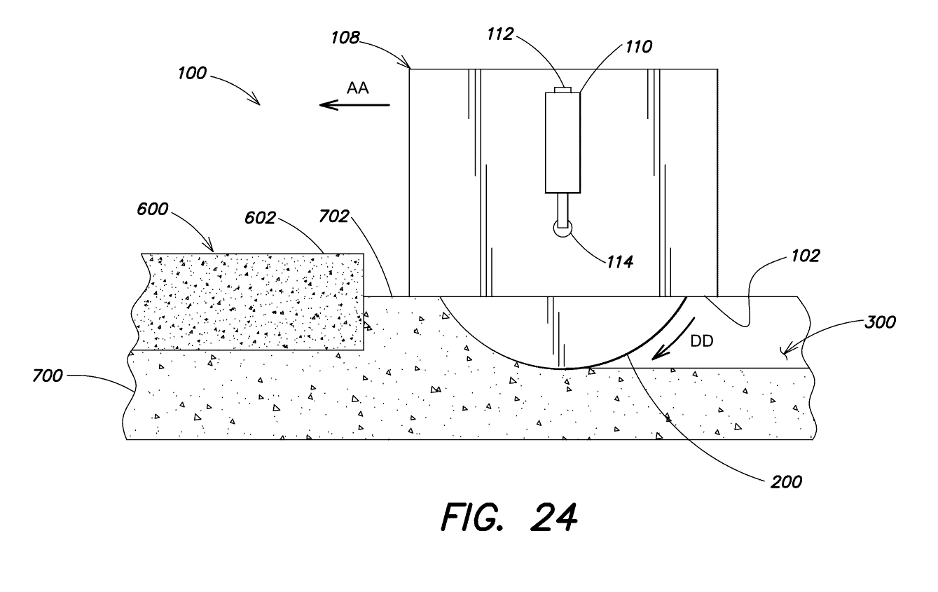

As mentioned above, a ground surface 402 can be any surface that provides for movement of foot or vehicular traffic. Disposed under the ground surface 402, typically is a sub-surface material 400. Sub-surface materials 400 include, but are not limited to, pavement, paving, concrete, asphalt, blacktop, cobblestone, brick, or other road base, grade or surface, or the like, or any combination of the foregoing. Disposed under the sub-surface material 400, typically is a base material 500. Base materials 500, can include, but is not limited to, base, sub-base, stone, course asphalt, dirt, sand, concrete, binder course, clay, aggregate, rubble, or the like, or any combination of the foregoing. Although FIGS. 21, 22 and 23 show formation of the microtrench 300 through the sub-surface material 400 and into the base material 500, it should be appreciated that in some instances the microtrench 300 need not extend into the base material 500 and may only extend into the sub-surface material 400 (e.g., as discussed further below in connection with FIGS. 24, 25 and 26).

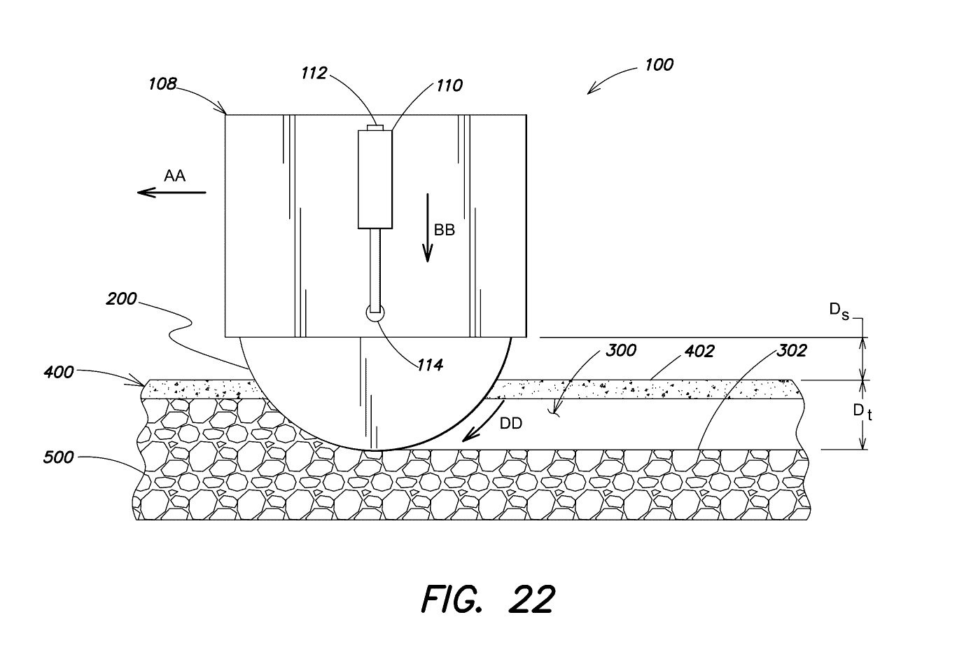

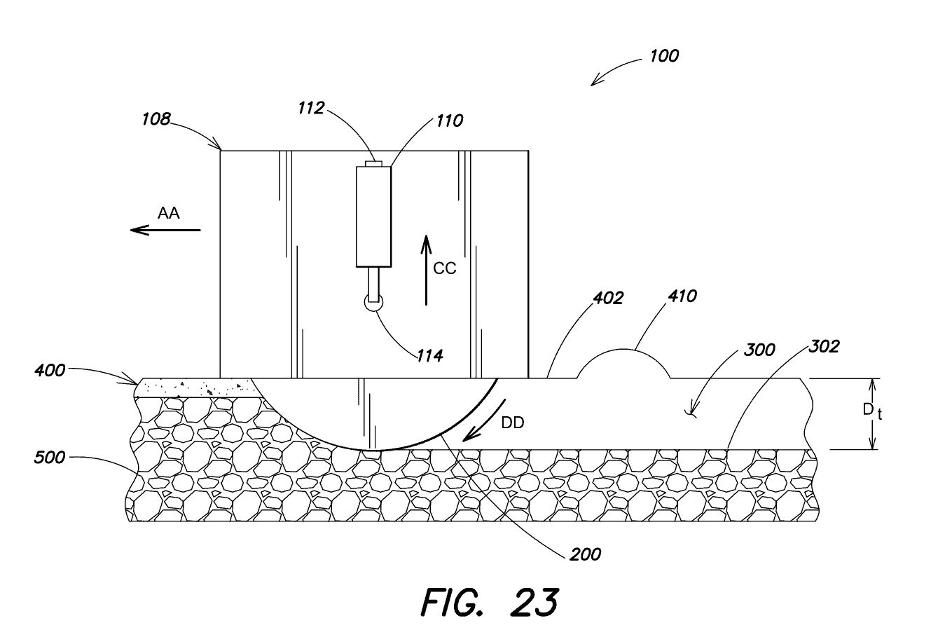

To maintain a substantially flat microtrench bottom 302, the cutting blade 200 is extended from the blade housing 108 in a direction BB as shown in FIG. 22. When cutting through elevated obstacle 410, the blade housing 108 is raised a distance D_{S} from the ground surface 402, and the cutting blade 200 is lowered an additional distance D_{S} to make the total cutting depth equal to D_{S}+D_{T}. After traversing the elevated obstacle 410, the blade housing 108 is lowered back in contact with the top surface 402 as the cutting blade 200 is retracted into the blade housing 108 in a direction CC. The cutter 100 resumes forming a microtrench at a depth D_{T}, as shown in FIG. 23.

As shown in FIGS. 21, 22, and 23, a substantially flat bottomed microtrench 300 of a minimum depth equal to depth D_{T} is formed without stopping the microtrenching cutting operation to change the cutting blade position within the blade housing. Conventionally, it was necessary to stop cutting a first microtrench before an elevated obstacle, and then start a second microtrench on the opposite side of an elevated obstacle. The two microtrenches were then connected together using a second cutter configured to form a deeper microtrench. Alternatively, a conventional method of microtrenching through an elevated obstacle included stopping the microtrenching operation, adjusting the cutting blade to a required depth, cutting through an elevated obstacle, stopping the microtrenching operation again, and adjusting the cutting blade to a required depth before resuming the microtrenching operation. Conventional methods often resulted in microtrenches that had wavy, undulating bottoms due to multiple cutting operations starting and stopping at different depths, which in turn caused conduits laid therein to be similarly bent. Sometimes, the bottoms of the microtrenches had steps and drop offs which resulted in conduits having sharp bends that form obstructions for fiber installation. Conduits laid in microtrenches created by conventional methods sometimes made installation of the fiber within the conduit very difficult for fiber installers.

The inventor has appreciated that this conventional method of forming a microtrench is difficult and time consuming. According to embodiments of the present invention, it is possible to continuously microtrench through a raised, elevated obstacle in a single swath without stopping the microtrench formation operation while a maintaining a minimum prescribed microtrench depth.

Some elevated obstacles, for example speed bumps, have a relatively narrow width within a path of formation of the microtrench, and a utility vehicle pulling a cutter would be at the same ground surface level, but on the opposite side of the speed bump as the base of the blade housing, as the cutter and cutting blade approach the elevated obstacle. Other elevated obstacles, like curbs and sidewalks, could be considered an elevated platform where the utility vehicle is raised above the level of the base of the blade housing as the cutter approaches the elevated obstacle. In these implementations, the angle of the base of the blade housing may change with respect to the ground surface.

FIGS. 24, 25, and 26 show examples of cross-sectional views of constructing a microtrench for cable installation, according to an embodiment of the present invention. In this embodiment, the microtrench 300 is formed only within the sub-surface material 700, and the microtrench 300 does not extend into the base material. A cutting blade 200 rotates in direction DD such that the bottommost cutting perimeter of the cutting blade 200 is rotating toward the same direction of travel AA as cutter 100 advances. As shown in FIG. 24, the base 102 of the blade housing 108 is in close contact with ground surface 702.

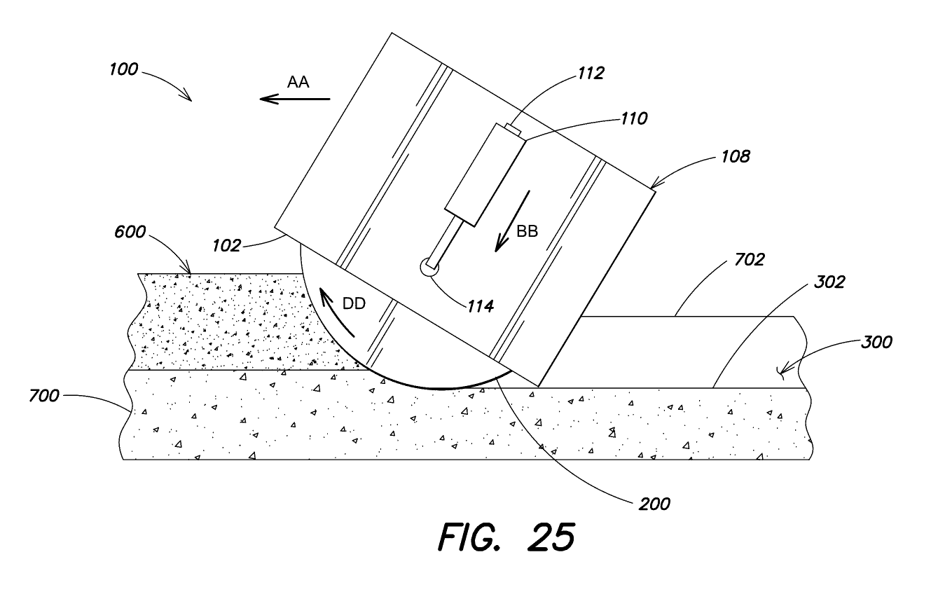

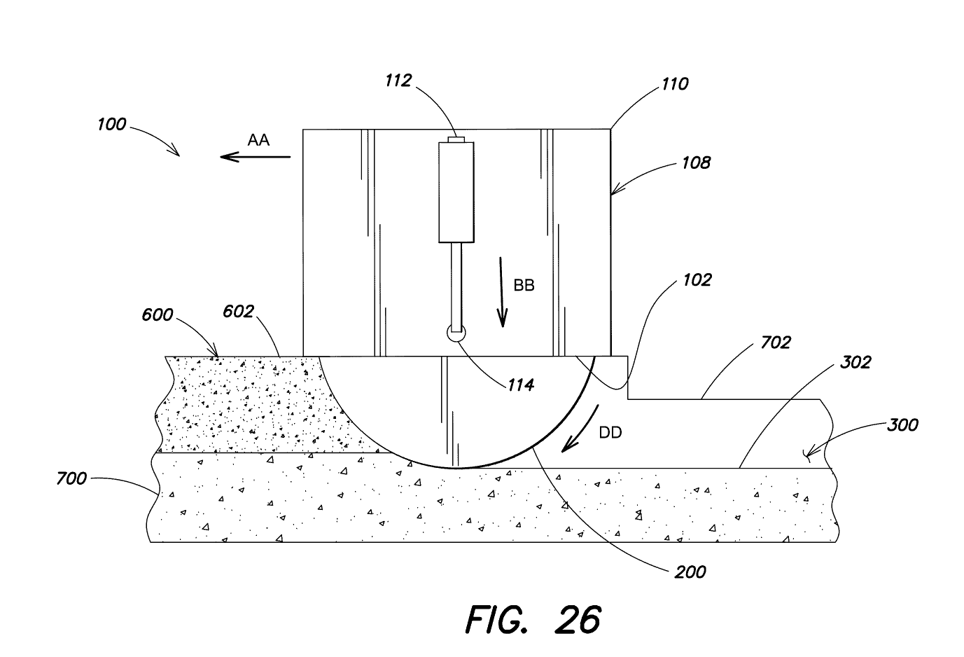

As cutter 100 advances toward elevated obstacle 600, the base 102 of the blade housing 108 becomes non-parallel to the ground surface 702. The elevated obstacle 600 can be constructed from materials such as stone, masonry blocks, cement, aggregate, cobblestone, manufactured pavers, asphalt, etc. To compensate for the change in the position of the blade housing 108, the cutting blade 200 is extended in direction BB to maintain a constant depth of microtrench 300 as shown in FIG. 25. As the cutter 100 traverses the elevated obstacle 600, and base 102 of the blade housing 108 returns to be in contact with the elevated obstacle top surface 602, blade adjustment mechanism 110 continues to extend cutting blade 200 from housing 108 in direction BB to maintain a flat microtrench bottom 302 as shown in FIG. 26.

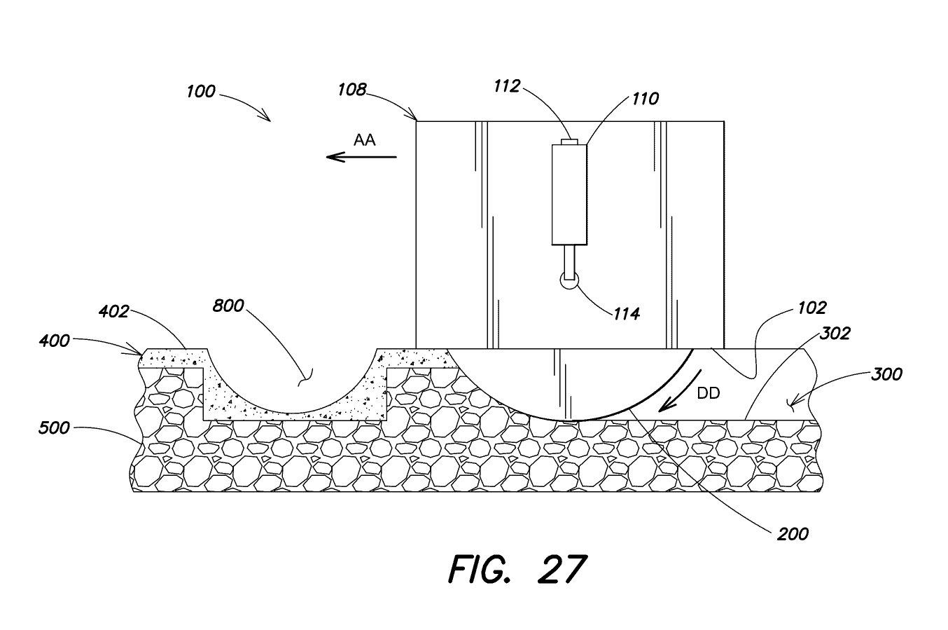

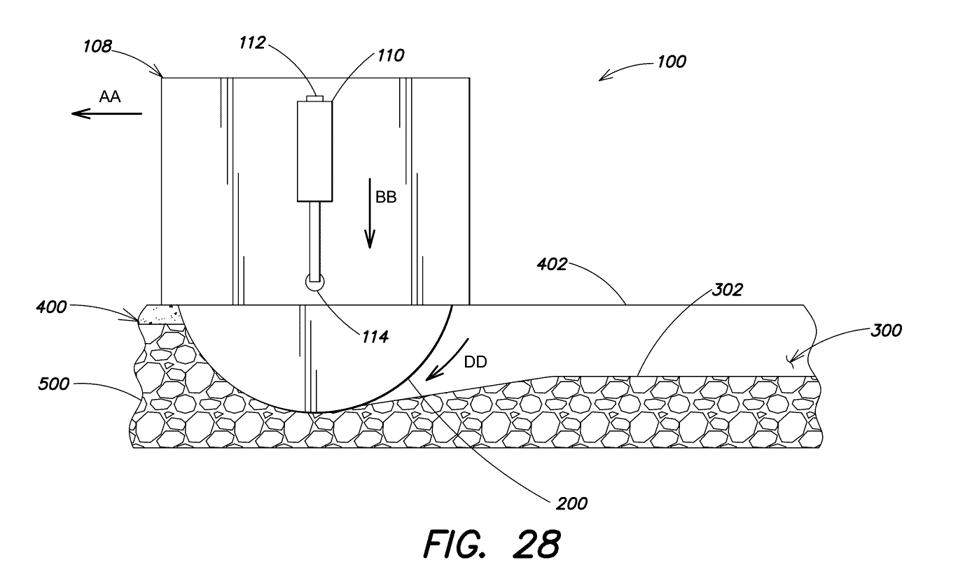

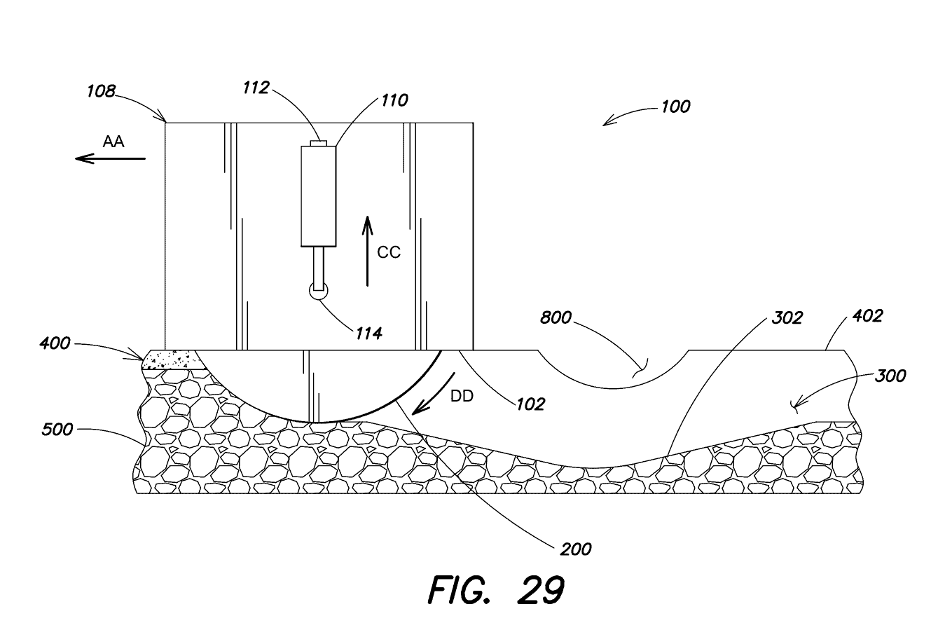

FIGS. 27, 28, and 29 show examples of cross-sectional views of constructing a microtrench for cable installation, according to an embodiment of the present invention. In this embodiment, the microtrench 300 is formed through the ground surface 400, through the sub-surface material 400, and the microtrench 300 extends into a base material 500. As shown in FIG. 27, in this implementation the cutter 100 is approaching a depressed obstacle 800 during formation of the microtrench 300. In order to form a microtrench 300 of sufficient depth to protect a cable installation, the cutter 100 extends blade 200 in direction BB as the cutter begins to traverse the depressed obstacle 800 as shown in FIG. 28. In this manner, the microtrench meets any minimum depth requirements for all points from microtrench bottom 302 to the ground surface 402 and the lowest point of the depressed obstacle 800. After traversing depressed obstacle 800, blade adjustment mechanism 110 retracts cutting blade 200 in direction CC and back into the blade housing 108 as shown in FIG. 29.

As mentioned above, a cable installation can be placed at the bottom of the microtrench (or void, or narrow channel). After laying the cables or conduit, the microtrench is filled with a filling material to protect the cables. A second filling material or topping material can be used to fill the remainder of the microtrench such that the top of the backfilled microtrench is at substantially the same elevation as the ground surface. In some implementations, a portion of the microtrench may be filled back with the debris collected from the cutting process. In some other implementations, the microtrench can be filled with native spoils, non-native sand, gravel, etc. In some other implementations, the microtrench can be filled with a non-shrinking and flowable filling material to protect the cables. The filling material hardens after a drying period. In some implementations, the filling material is filled up to the top of the microtrench. In some other implementations, the filling material is filled only up a certain depth that is below the top surface of the microtrench. The remaining portion of the microtrench is filled with a topping material that adheres to the covering surface and seals the microtrench. Thus, the microtrench may have a bottom section filled with a first filling material, and a top section, which is filled with a second filling material or topping material. In some implementations, the filling material is a two part polyurea material.

The top section of the microtrench can be filled with a topping material to cover and seal the microtrench. The topping material can, like the filling material, be flowable compound that can rigidify upon drying. In some implementations, the topping material can be configured to adhere to the top surface of the filling material at the interface. In some implementations, the topping material, unlike the underlying filling material, can be compressible or elastic upon rigidifying. The compressibility of the topping material can allow aside walk section to expand in the horizontal direction without significant resistance. As such, the topping material can have properties similar to the material used for forming the expansion joint. The topping material may also act as a sealant so as to prevent any water or fluids from seeping into the microtrench. In some implementations, the topping material can include mastic. In some other implementations, the topping material can include silicone caulking. In some other implementations, any material that is compressible and can provide a seal can be employed.

The microtrench may be formed by lowering a rotating circular cutting blade through a ground surface. Various embodiments of a cutting blade employed for cutting the microtrench and the associated machinery are described above. The cutting blade is lowered until a desired depth D_{T} of the microtrench is achieved. In some implementations, the depth D_{T} can be measured from the ground surface 402. In some implementations, the depth D_{T} is selected to be between 2 to 12 inches. In some other implementations, the depth D_{T} is selected to be between 2 to 15 inches. Having a depth of no more than 12 to 15 inches can avoid penetration of existing utility lines within the sidewalk, and thereby may speed up the permitting process required to construct at the work site. Furthermore, excessive depth of the microtrench may inhibit effective evacuation of the leftover debris and cuttings. Nonetheless, the depth of the microtrench is not limited to 12 to 15 inches.

The microtrench is formed with a width W_{T} that is sufficient to accommodate the cables. In some implementations, the width W_{T} can be between about 0.5 inches to about 1.5 inches. In some other implementations, the width W_{T} can be between about 0.68 inches to about 1.25 inches. Selecting the width W_{T} can also be based on the economics of the amount of filling material (and perhaps the topping material) that may be required to completely fill the microtrench 300. That is, the volume of filling material required to fill the microtrench may increase with the increase with the width W_{T}, thus increasing overall cost. In some implementations, the width W_{T} of the microtrench may be a function, in part, of the thickness of the blade used for cutting the microtrench 300. In some implementations, the width W_{T} of the microtrench may be greater than the width of the blade. In some implementations, the width W_{T} of the microtrench may be non-uniform along the length of the microtrench 300. In some instances, the width W_{T} of the microtrench may be non-uniform along the height of the microtrench 300. This non-uniformity may be caused due to voids created by dislodged rocks, stones, or other material in the microtrench's sidewalls.

As the microtrench is cut, it can be evacuated of any cuttings and debris. The evacuation, can be carried out using a vacuuming system that operates simultaneously with the operation of the cutting blade. In this manner, a stream of cuttings and debris produced by the cutting blade is immediately evacuated by the vacuuming system.

The cables can be laid into a length of the microtrench that has been evacuated. The cables can be laid manually or using a cable laying machine. In some implementations, more than two cables can be laid into the microtrench. In some other implementations, a conduit may be laid into the microtrench, which conduit may include one or more cables. In some other implementations, the conduit may include no cables, which may be pulled into the conduit at a future point in time. The cables can include, without limitation, fiber optic cables, electrical cables, wire cables, communication cables, etc.

As mentioned above, after the cables have been laid, the filling material is poured or pumped into the microtrench. In some implementations, the filling material can be poured manually into the microtrench. In some other implementations, a pump or a machine may be used to pump the filing material from a reservoir into the microtrench via a pipe or a duct. As mentioned above, the filling material is preferably flowable and non-shrinking. Being flowable allows the filling material to fill the bottom section of the microtrench and bonds or encases the cables. The filling material can include, without limitation, materials such as, plaster, grout or mortar. In some implementations, grout can be used as the filling material. The grout can be flowed into the microtrench using a hand-held duct coupled to a grout pump. In some implementations, the filling material is compatible with wet environments and can be used with a semi-wet or wet-cutting process.

In some implementations, the filling material can be viscid, sticky, and have a fluid consistency. In addition, the filling material can have a certain viscosity that allows it to flow into the microtrench and substantially surround the cables. The filling material can also flow into voids in the sidewall of the microtrench left behind by dislodged rocks or stones. Due to the flowability of the filling material, formation of air bubbles or spaces within the filled bottom section and at the interface with the topping material, can be reduced or entirely avoided. It should be noted that having spaces or air bubbles within the microtrench may cause the spaces and air bubbles to fill with water or other fluids seeping in from the top surface. Water, for example, can expand at freezing temperatures, and may damage the integrity of the bottom section or top section in a process commonly known as frosting. Thus, by avoiding or reducing the formation of spaces and air bubbles, the reliability and longevity of the cable installation as a whole can be improved.

Also mentioned above, the filling material can also be non-shrinking upon hardening. That is, the filling material can be non-compressible, non-expandable, with no contraction when it hardens. In some implementations, the filling material may shrink no more than 1 percent of its volume upon drying and hardening at ambient temperature. The non-shrinking property of the filling material reduces or entirely avoids the formation of air bubbles or spaces in the bottom section upon hardening. As discussed above, reducing or avoiding air bubbles or spaces can improve the reliability and longevity of the cable installation. In some implementations, the filling material can begin to rigidify within the first hour of being poured or pumped into the microtrench. In some implementations, the filling material may completely rigidify within about three to about twelve hours after being poured or pumped into the microtrench. The dried and rigid filling material may have very low hydraulic permeability. In some implementations, the hydraulic permeability of the filling material can be less than 0.0000001 cm/s. The filling material with low permeability can prevent water from seeping into the microtrench through the filling material, and therefore, reduce any damage caused by frosting. In some implementations, the hardness of the filling material upon rigidification can be substantially equal to or greater than the hardness of the curb. In some implementations, a grout sold under the name SUPERGROUT® may be used as the filling material. In some other implementations, Portland cement may be used as the filling material.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. An apparatus for forming a microtrench through a ground surface, the apparatus comprising:
a blade housing configured to mechanically support and substantially surround a cutting blade when the cutting blade is installed in the blade housing; and
an automated blade adjustment mechanism operably coupled to the blade housing to vary, in response to a control input, a position of the cutting blade within the blade housing, when the cutting blade is installed in the blade housing, so as to correspondingly vary a depth of the microtrench relative to the ground surface.

2. The apparatus of claim 1, further comprising:
at least one port in the blade housing for conducting debris created by the cutting blade cutting the microtrench.

3. The apparatus of claim 2, wherein the blade housing comprises a base forming a blade opening for the cutting blade to protrude for cutting the microtrench, the base configured to substantially contact the ground surface flanking and along a length of the microtrench during use of the apparatus.

4. The apparatus of claim 3, further comprising:
the cutting blade for cutting the microtrench through the ground surface.

5. The apparatus of claim 4, wherein the automated blade adjustment mechanism varies the position of the blade, in response to the control input, such that the microtrench is formed through the ground surface and into a sub-surface material.

6. The apparatus of claim 4, wherein the automated blade adjustment mechanism varies the position of the blade, in response to the control input, such that the microtrench is formed through the ground surface and through a sub-surface material and into a base material.

7. The apparatus of claim 3, wherein the cutting blade is a single, circular blade having a cutting perimeter, a diameter, and a central hub portion for attachment to the apparatus.

8. The apparatus of claim 7, wherein the diameter of the cutting blade is from about 24 inches to about 48 inches.

9. The apparatus of claim 3, wherein the cutting perimeter of the cutting blade has a first thickness and the central hub portion of the cutting blade has a second thickness, wherein the first thickness is greater than the second thickness.

10. The apparatus of claim 3, wherein the cutting perimeter of the cutting blade is configured to form the microtrench having a width from 0.5 inches to about 1.5 inches in a single pass.

11. The apparatus of claim 3, wherein the cutting perimeter of the cutting blade is diamond impregnated.

12. The apparatus of claim 3, wherein the cutting perimeter of the cutting blade comprises removable conical cutting teeth and/or fixed teeth.

13. The apparatus of claim 3, wherein the cutting perimeter of the cutting blade is configured to cut in only one rotational direction.

14. The apparatus of claim 3, wherein the blade housing further comprises a first side and a second side, and the first side of the blade housing mechanically supports the cutting blade.

15. The apparatus of claim 14, wherein second side of the blade housing is removably coupled to the first side of the blade housing.

16. The apparatus of claim 14, wherein the first side, the second side, and the base form an inner volume to facilitate improved vacuum performance to remove debris created by the cutting blade cutting the microtrench.

17. The apparatus of claim 14, wherein the apparatus is configured to be raised, lowered, tilted side-to-side, and angled front-to-back with respect to the ground surface.

18. The apparatus of claim 14, wherein the blade housing comprises at least one vent to facilitate air flow through the blade housing.

19. The apparatus of claim 18, wherein the at least one vent is adjustable for attaining a particular rate for the air flow within the blade housing.

20. The apparatus of claim 3, wherein the at least one port in the blade housing is located proximate to a point where the cutting blade exits the ground surface during formation of the microtrench and extends in a direction tangential to a circumference of the cutting blade, the at least one port for connecting to a vacuum system.

21. The apparatus of claim 3, wherein the blade housing further comprises a first side and a second side and the at least one port in the blade housing is located on the first and/or the second side of the blade housing and proximate to a point where the cutting blade cuts through the ground surface during formation of the microtrench, the at least one port for attaching a debris chute.

22. The apparatus of claim 1, further comprising:
a blade motor for powering the cutting blade.

23. The apparatus of claim 22, wherein the blade motor is hydraulically, pneumatically, electrically, or mechanically powered by an internal combustion engine or electric generator.

24. The apparatus of claim 23, wherein the blade motor is hydraulically powered by an internal combustion engine.

25. The apparatus of claim 22, wherein the blade motor changes position as the position of the cutting blade is varied in response to the control input.

26. The apparatus of claim 22, wherein the blade motor comprises a direct drive to the cutting blade.

27. The apparatus of claim 22, further comprising:
a transmission disposed between the blade motor and the cutting blade.

28. The apparatus of claim 3, wherein the automated blade adjustment mechanism provides for a change in the position of a cutting perimeter of the cutting blade relative to the base of the blade housing while the cutting blade is rotating so as to vary the depth of the microtrench through the ground surface.

29. The apparatus of claim 28, wherein the change occurs without stopping formation of the microtrench.

30. The apparatus of claim 1, further comprising a power source coupled to the automated blade adjustment mechanism, wherein the power source powers the automated blade adjustment mechanism in two opposite directions.

31. The apparatus of claim 30, wherein the power source is hydraulic, pneumatic, or electric.

32. The apparatus of claim 1, wherein the automated blade adjustment mechanism provides continuous adjustability of the position of the cutting blade between two endpoints of adjustment.

33. The apparatus of claim 14, further comprising:
a sealing member to seal a slot exposed in the first side of the blade housing when the automated blade adjustment mechanism raises the position of the cutting blade within the blade housing.

34. The apparatus of claim 33, wherein the sealing member is a folded membrane.

35. The apparatus of claim 33, wherein the sealing member is a polymer and/or a rubber material.

36. The apparatus of claim 33, wherein the sealing member is a metal sheet or a polymer sheet.

37. A system for forming a microtrench through a ground surface, the ground surface having an elevated obstacle or a depressed obstacle in a path of formation of the microtrench, the system comprising:
a cutter for forming the microtrench through the ground surface, the cutter comprising:
a cutting blade for cutting the microtrench through the ground surface;
a blade motor for powering the cutting blade;
a blade housing configured to mechanically support and substantially surround the cutting blade;
at least one port in the blade housing for conducting debris created by the cutting blade cutting the microtrench; and
an automated blade adjustment mechanism operably coupled to the blade housing to vary, in response to a control input, a position of the cutting blade within the blade housing so as to correspondingly vary a depth of the microtrench relative to the ground surface; and
a first vehicle coupled to the cutter for advancing the cutter along the path of formation of the microtrench through the ground surface, the first vehicle comprising:
a power source for powering the automated blade adjustment mechanism and for powering the cutting blade; and
an operator control station including an output device for transmitting the control input to the automated blade adjustment mechanism.

38. The system of claim 37, further comprising:
a vacuum system for collecting the debris created by the cutting blade cutting the microtrench, the vacuum system including a flexible hose coupled to the at least one port of the blade housing.

39. The system of claim 38, further comprising:
a second vehicle, wherein the vacuum system is coupled to the second vehicle.

40. The system of claim 37, wherein the blade housing comprises a base forming a blade opening for the cutting blade to protrude for cutting the microtrench, the base configured to substantially contact the ground surface flanking and along the path of formation of the microtrench during use of the system.

41. A method of forming a microtrench through a ground surface and into a sub-surface material below the ground surface using a cutting apparatus, the method comprising:
A) varying a position of a cutting blade within a blade housing of the cutting apparatus, via a hydraulic blade adjustment mechanism, so as to vary a depth of the microtrench relative to the ground surface while forming the microtrench.

42. The method of claim 41, further comprising:
B) forming a first portion of the microtrench through the ground surface, the first portion of the microtrench having a first depth; and
C) forming a second portion of the microtrench through the ground surface, the second portion of the microtrench having a second depth, wherein the second portion of the microtrench is formed by varying the position of the cutting blade within the blade housing of the cutting apparatus, via the hydraulic blade adjustment mechanism.

43. The method of claim 41, wherein varying the position of the cutting blade within the blade housing of the cutting apparatus, via the hydraulic blade adjustment mechanism, occurs concurrently with advancing the cutting apparatus along the ground surface.

44. The method of claim 41, wherein the blade housing comprises a base forming a blade opening for the cutting blade to protrude for cutting the microtrench, and wherein the method further comprises:
B) contacting the base of the blade housing with the ground surface flanking along the first portion and the second portion of the microtrench during formation of the microtrench.

45. The method of claim 41, wherein A) comprises varying the position of the blade such that the microtrench is formed in the sub-surface material, and wherein the sub-surface material is selected from a group consisting of pavement, paving, concrete, asphalt, blacktop, cobblestone, brick, road base, and combinations thereof.

46. The method of claim 45, wherein A) comprises varying the position of the blade such that the microtrench is formed through the sub-surface material and into a base material, and wherein the base material is selected from a group consisting of base, sub-base, stone, course asphalt, dirt, sand, concrete, binder course, clay, aggregate, rubble, and combinations thereof.

47. The method of claim 41, wherein the depth of the microtrench relative to the ground surface is from about 2 inches to about 15 inches.

48. The method of claim 41, wherein the microtrench has a width from about 0.5 inches to about 1.5 inches.

49. A method of forming a microtrench through a ground surface using a cutting apparatus, the ground surface including an elevated obstacle, the method comprising:
A) forming a first portion of the microtrench through the ground surface with the cutting apparatus, the cutting apparatus comprising:
a blade housing configured to mechanically support and substantially surround a cutting blade; and
a blade adjustment mechanism operably coupled to the blade housing to vary, in response to a control input, a position of the cutting blade within the blade housing so as to correspondingly vary a depth of the microtrench relative to the ground surface;
B) varying the position of the cutting blade within the blade housing of the cutting apparatus, via the blade adjustment mechanism, so as to vary the depth of the microtrench relative to the ground surface; and
C) forming a second portion the microtrench though the elevated obstacle with the cutting apparatus, at the varied position in B), such that the microtrench has the substantially flat bottom that is substantially level with the first portion of the microtrench.

50. The method of claim 49, wherein A) and C) comprises cutting the microtrench into a sub-surface material selected from a group consisting of pavement, paving, concrete, asphalt, blacktop, cobblestone, brick, road base, and combinations thereof.

51. The method of claim 50, wherein A) and C) comprise cutting the microtrench into a base material selected from a group consisting of base, sub-base, stone, course asphalt, dirt, sand, concrete, binder course, clay, aggregate, rubble, and combinations thereof.

52. The method of claim 49, wherein the depth of the microtrench is from about 2 inches to about 15 inches.

53. The method of claim 49, wherein the microtrench has a width from about 0.5 inches to about 1.5 inches.

54. The method of claim 49, wherein forming the first portion of the microtrench through the ground surface and forming the second portion the microtrench though the elevated obstacle are performed sequentially without stopping formation of the microtrench.

55. The method of claim 49, wherein varying the position of the cutting blade within the blade housing and forming a second portion the microtrench though the elevated obstacle are performed concurrently such that the position of the cutting blade is varied as the second portion of the microtrench is cut through the elevated obstacle.

56. The method of claim 49, wherein varying the position of the cutting blade within the blade housing includes lowering the blade adjustment mechanism to extend the cutting blade from the blade housing of the cutting apparatus.

57. A method of forming a microtrench through a ground surface using a cutting apparatus, the ground surface including a depressed obstacle and the microtrench having a minimum depth below the depressed obstacle, the method comprising:
A) forming a first portion of the microtrench through the ground surface with the cutting apparatus, the cutting apparatus comprising:
a blade housing configured to mechanically support and substantially surround a cutting blade; and
a blade adjustment mechanism operably coupled to the blade housing to vary, in response to a control input, a position of the cutting blade within the blade housing so as to correspondingly vary a depth of the microtrench relative to the ground surface;
B) varying the position of the cutting blade within the blade housing of the cutting apparatus, via the blade adjustment mechanism, so as to vary the depth of the microtrench relative to the ground surface; and
C) forming a second portion the microtrench though the depressed obstacle, at the varied position in B), such that the microtrench has the minimum depth below the depressed obstacle.

58. The method of claim 57, wherein A) and C) comprise cutting the microtrench into a sub-surface material selected from a group consisting of pavement, paving, concrete, asphalt, blacktop, cobblestone, brick, road base, and combinations thereof.

59. The method of claim 58, wherein A) and C) comprise cutting the microtrench into a base material selected from a group consisting of base, sub-base, stone, course asphalt, dirt, sand, concrete, binder course, clay, aggregate, rubble, and combinations thereof.

60. The method of claim 57, wherein the depth of the microtrench is from about 2 inches to about 15 inches.

61. The method of claim 57, wherein the microtrench has a width from about 0.5 inches to about 1.5 inches.

62. The method of claim 57, wherein forming the first portion of the microtrench through the ground surface and forming the second portion the microtrench though the depressed obstacle are performed sequentially without stopping formation of the microtrench.

63. The method of claim 57, wherein varying the position of the cutting blade within the blade housing and forming a second portion the microtrench though the depressed obstacle are performed concurrently such that the position of the cutting blade is varied as the second portion of the microtrench is cut through the depressed obstacle.

64. The method of claim 57, wherein varying the position of the cutting blade within the blade housing includes lowering the blade adjustment mechanism to extend the cutting blade from the blade housing of the cutting apparatus.
